(19) United States
(12) Patent Application Publication
(10) Pub. No.: US 2006/0048808 A1
(43) Pub. Date: Mar. 9, 2006

(54) Solar, catalytic, hydrogen generation apparatus and method

(76) Inventors: Jack Hugh Ruckman, Reno, NV (US); Alma K. Schurig, Springville, UT (US); Keith Anderson, Springville, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 10/937,143

(22) Filed: Sep. 9, 2004

(51) Int. Cl. H01L 35/00

(52) U.S. Cl. 136/206

(57) ABSTRACT

An apparatus for producing hydrogen may include a collector of radiation to concentrate solar radiation on a converter having an absorptivity to convert the solar radiation to thermal energy to drive a chemical process using a feedstock to dissociate into an output chemical and a byproduct. A separator separates the output and byproduct, after which a reactor reacts the output to form a storage chemical, reactive to produce energy but sufficiently stable for safe handling outside designation as an energetic material. The separator may have a porosity to substantially pass hydrogen and block oxygen and water. A sweep gas may sweep hydrogen away from the separation barrier to change equilibrium. Catalysts may reduce temperature of dissociation and a subsequent reaction to combine it in a more stable, storable form.

### BACKGROUND

1. The Field of the Invention

This invention relates to solar energy collection and storage and, more particularly, to novel systems and methods for solar generation and storage of chemical energy.

2. Technical Background of the Art

Water can be, and has been, dissociated into hydrogen and oxygen by several methods. Each method has its advantages and disadvantages. These are complicated by the precautions necessary to handle the products due to their extreme reactivity.

Among the methods of water dissociation are electrolysis and thermal dissociation. Electrolysis occurs when a direct current is applied to two electrodes that are placed in a water bath. Hydrogen is produced at the cathode (negatively charged electrode) and oxygen is produced at the anode (positively charged electrode.) The advantage to this system is that the oxygen and hydrogen are separated as they are produced. Therefore, no explosive solution of the products is formed, and no additional separation mechanism is required. Depending upon the source of electrical energy, this process may not be particularly efficient thermodynamically or environmentally.

For instance, if the electrical energy is derived from a standard fossil fuel fired generation plant, much inefficiency is involved in each aspect of the generation, delivery, and utilization of the electrical energy. One should consider the inefficiency brought about by the over-voltage required to bring about the separation of the atoms of the water.

Additional inefficiencies start at the generation station and include vaporization and condensation of the working fluid (usually water) wherein the gaseous phase is used to drive a turbine. The working fluid emerges from the turbine, still in the gaseous phase. The vaporization energy is then discarded by condensing the fluid back to liquid in order to pump it back into the boiler. There are frictional losses through the turbine.

The turbine drives a generator, which also has frictional losses as well as eddy current and resistance losses. The generated electricity is delivered as alternating current over transmission lines that have line losses, after which the alternating current must be converted to direct current, imparting additional energy losses. The combined energy losses require that more fossil fuel be combusted, resulting in additional emissions of particulates, acidifying gases, ozone, and carbon dioxide.

Typically, hydrogen is stored under pressure or by liquefying it. This requires additional energy through the electrical power lines. Oxygen too, if it is to be stored, requires compression or liquefaction.

Thermal dissociation of water is typically carried out at temperatures ranging from about 1,500° C. to about 3,500° C. Some experiments contemplate a range of about 2,000° C. to 2,200° C. as a preferred temperature range. A complication of thermal decomposition of water is that the hydrogen and oxygen are typically generated in the same space. This increases the probability of reverse reaction, not excluding the possibility of explosion. Separation of the hydrogen and oxygen may be accomplished by a variety of mechanisms. Among separation techniques is the use of an oxygen permeable wall using refractory oxides such as zirconia, lanthana, ceria and so forth. Oxygen permeating through such a layer and into another chamber may be removed by sweeping that chamber with a non-reactive gas such as nitrogen and/or carbon dioxide. If the system can use thermal energy for some beneficial use, the sweep can be effected using a reactive gas such as carbon monoxide, methane, or other hydrocarbons to remove the oxygen.

A prime source of thermal energy is radiation from the sun. Among methods of using solar energy are systems that provide a material pervious to hydrogen, but impervious to oxygen. Energy from the sun is directed from a concentrating solar collector to heat water to dissociation temperatures on the order of 2,800°Kelvin. The hydrogen permeates the membrane of the reaction chamber, thereby effecting a separation. Such high temperatures may require materials of construction like oxide ceramics, such as thorium oxide, and possibly zirconium oxide. A solar concentrator may provide a temperature of approximately 6,000°Kelvin at the focus. This can easily provide sufficient energy density to attain 2,800°Kelvin in the water for dissociation.

Other permeable wall solar reactors are referenced in the literature that may preferentially permit hydrogen generation and transport at temperatures in the range of 1,500° to 3,000°Kelvin. Membranes for these reactors may be formed from a platinum group metal, refractory oxides, such as ceric or other rarer oxides, hafnium oxide, uranium oxide, strontium oxide, zirconia, alumina, thoria, lime, beryllium oxide, or refractory nitrides, depending on temperatures and pressures at which such a diffusion membrane may operate. Since hydrogen can diffuse through palladium even with no porosity, palladium may be used as a barrier membrane. The palladium is very expensive and may not withstand the operating temperature of some reactors. Because of its expense it can be used only in limited amounts. Limited surface area of the palladium along with the permeation rate of hydrogen through the metal will limit the hydrogen production rate.

Separation technologies are referenced for devices operating at 2,000°Kelvin. At this temperature, materials of construction are easier to locate. Most sources agree, however, that temperatures on the order of 3,000°Kelvin are preferable since they provide a much greater yield.

### BRIEF SUMMARY AND OBJECTS OF THE INVENTION

In view of the foregoing, it is a primary object of the present invention to provide a highly efficient energy collection and storage system operable to promote reactions at comparatively modest temperatures, typically under 1000° C. for both dissociation and re-composition reactions.

In one embodiment of an apparatus and method in accordance with the invention, radiation from the sun may be directed to a collector and reactor system integrated to provide hydrogen as an energy output. Solar energy heats a wall within a cavity containing water vapor. One surface of the cavity contains a catalyst. Hydrogen is formed on the catalytic surface. The catalytic surface is porous, and may be provided with a nanofiber (or nanotube) carbon structure to readily adsorb and transport the hydrogen. Meanwhile, the wall has a limited pore size, which may be on the order of the mean-free path of hydrogen molecules and less than the diameter of oxygen and water molecules. Accordingly, virtually all the gas that can permeate the wall will be hydrogen. Any small amount of oxygen that may pass through the semi-permeable wall may be removed by catalytic scavenging or the like downstream.

A suitable wall may be formed of a ceramic having a pore size suitable to pass hydrogen readily. Certain ceramics are also available that will pass hydrogen, and will substantially eliminate passage of oxygen.

On the opposite side of the wall defining the thermolysis or thermal dissociation chamber, a purge gas or sweep gas may pass through, carrying away hydrogen in order to maintain a low partial pressure of hydrogen. Accordingly, hydrogen will be motivated by the concentration gradient and partial pressure gradient to rapidly pass through the wall from the thermal decomposition chamber into the sweep chamber where a sweep gas such as nitrogen may carry the hydrogen away.

Proton exchange membranes do not tend to provide a sufficiently rapid removal of hydrogen. Moreover, the high energy densities and small surface areas contemplated for a solar target or collector exposed to concentrated solar radiation would typically be mismatched to such materials. In an apparatus and method in accordance with the invention, the dissociation chamber need not require specialty materials such as cermats (ceramic-metals), or organic salt PEM crystals. Thus, it is less subject to dissolution or loss of effectiveness that may occur with other membranes.

In one embodiment, an apparatus may include a chamber for dissociating water into hydrogen and oxygen in which a pore space is treated with a rare earth pentanickel catalyst. This catalyst promotes the decomposition of water and immediately absorbs hydrogen gas, conducting it through the barrier wall or membrane in order to deliver the hydrogen to be swept away by a sweep gas. One promising aspect of such a mechanism is the fact that the pentanickel material catalyzes production of ammonia from hydrogen in the presence of nitrogen gas.

Accordingly, if nitrogen is used as a sweep gas, hydrogen can be immediately reacted on the sweep side of the barrier wall to produce anhydrous ammonia which subsequently may be cooled to liquid phase. Since the density of liquid ammonia is 1325 grams per liter, and contains about 17.6 percent hydrogen, this provides 233 grams of hydrogen per liter of storage, a density greater than liquid hydrogen. Effectively, a liter of ammonia could contain approximately 7.8 kilowatt hours of energy in hydrogen to be cracked from the ammonia for use. Meanwhile, anhydrous ammonia can be handled by conventional technologies that do not require excessive pressures, temperatures, or esoteric and expensive metals.

A hydrogen generator in accordance with the invention was developed to take advantage of heat from many sources, including solar and other alternative energy sources. For example, thermal effluents from industrial processes, and the like may provide energy to be recovered. Solar energy has the advantage that it provides a high thermodynamic availability, which can be translated into very high temperatures. Nevertheless, an apparatus and method in accordance with the invention require comparatively modest temperatures on the order of 400° to 900° C., rather than the 2,000° to 3,500° C. temperatures typical in conventional dissociation systems. Disadvantages of high temperatures include efficiency losses and materials “life” reduction. Re-radiation increases with the fourth power of temperature, increasing losses. Chemical breakdown of structural materials increases with temperature.

Moreover, a generator in accordance with the invention may rely on catalysis of a reversible dissociation reaction, and then apply LeChatlier's principle. That is, concentration gradients or partial pressure gradients of a gas drive migration of species. Accordingly, if a reaction is in equilibrium, removal of one species tends to drive the equilibrium point toward more production of that species. Thus, where water is constituted by H₂O and is separated into H₂ and O₂, removal of H₂ from one side of a permeable (semi-permeable) wall will tend to lower the hydrogen partial pressure, and thus drive the equilibrium reaction on the opposite side toward production of more hydrogen.

Energy plus water will result in hydrogen and oxygen. Thus, water can be broken down by addition of energy to break the chemical bonds therein. Meanwhile, hydrogen and oxygen combine, typically by combustion or the like, to provide water and energy. Thus, a balanced reaction exists, which can be driven in either direction, as it seeks equilibrium. The equilibrium can be shifted to favor the breakdown of water if either of the breakdown products is removed.

Meanwhile, catalysis provides a lower threshold energy for any particular reaction. Thus, a catalyzed dissociation with rapid removal of a decomposition species (e.g. hydrogen) tends to shift the equilibrium toward replacing the removed hydrogen. Thus, the reaction continues to proceed to replace hydrogen and establish equilibrium. Meanwhile, a sweep gas or the reaction of NH₃ production has removed the hydrogen for further processing.

Consistent with the foregoing, and in accordance with the invention as embodied and broadly described herein, a method and apparatus are disclosed in one embodiment of the present invention as including a solar tracker, an array of reflectors, a collector, conversion of radiant energy to thermal energy, conversion of thermal energy to chemical energy, and conversion of chemical energy from one species to another in order to facilitate simpler handling, storage, and distribution.

A method of practice in accordance with one embodiment of the invention may include thermal dissociation of water, catalytic augmentation thereof, “nano-” porous separation, and catalytic conversion of hydrogen to ammonia.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of apparatus and methods in accordance with the invention and are, therefore, not to be considered limiting of its scope, the invention will be described with additional specificity and detail through use of the accompanying drawings in which:

FIG. 1 is a schematic block diagram of an apparatus in accordance with the invention for collecting energy, dissociating water, and isolating hydrogen, including optional chemical conversion included in the processing for storage;

FIG. 2 is a schematic diagram of a system in accordance with the invention for collecting energy, storing that energy in hydrogen, and storing the hydrogen as hydrogen or a compound thereof;

FIG. 3 is a schematic diagram of an alternative embodiment of a system in accordance with the invention using an energy source to drive a generator system converting a supply of water into a storage of hydrogen or a composition thereof;

FIG. 4 is a schematic block diagram of an apparatus and process for collecting energy, generating hydrogen, and processing that hydrogen for storage;

FIG. 5 is a schematic perspective view of one embodiment of a collector core for dissociating water to produce hydrogen in accordance with the invention;

FIG. 6 is a schematic diagram of an electrophoretic separation mechanism through a proton conducting membrane;

FIG. 7 is a schematic diagram of a segment of a combination of heat exchange in counter flow for application to an apparatus in accordance with the invention;

FIG. 8 is a schematic cross-sectional view of a segment of one embodiment of a direct dissociation reactor and conversion or re-composition reactor, in an integrated system;

FIG. 9 is a schematic perspective view of an alternative embodiment of cross flow heat and mass exchange in a direct steam-to-hydrogen-to-ammonia reaction system in accordance with the invention;

FIG. 10 is a perspective view of a segment of one embodiment of a counter flow reactor in which the reactor barrier is placed in compression as a result of pressure differentials between flows;

FIG. 11 is a perspective view of an alternative embodiment of a reactor wherein a comparatively higher interior pressure places the barrier material in tension in an apparatus in accordance with the invention;

FIG. 12 is a perspective view of a segment of an alternative embodiment of a double reactor for converting energy from steam to hydrogen and then to ammonia in an insulated system in accordance with the invention;

FIG. 13 is a schematic cross sectional view of the effect of tortuous passages through the barrier wall or semi-permeable material of a reactor in an apparatus in accordance with the invention;

FIG. 14 is a schematic cross sectional view of a reactor wall illustrating several alternative mechanisms and elements that may be used alone, or in any combination including or not including any other optional element thereof;

FIG. 15 is a schematic cross sectional view of one embodiment of a concurrent flow reactor in accordance with the invention;

FIG. 16 is a schematic cross-sectional view of an alternative embodiment of a reactor relying on counter flow and an inclined mounting attitude;

FIG. 17 illustrates a schematic cross sectional view of one embodiment of a reactor combining a solar collection window therewith;

FIG. 18 is a schematic cross-sectional view of one embodiment of a double loop, heat-exchanging version of a reactor in accordance with the invention;

FIG. 19 is a schematic cross-sectional view of an alternative embodiment of a fully double reacting conversion system for dissociation and storage in accordance with the invention;

FIG. 20 is a schematic diagram of one experimental unit demonstrating the catalyzed dissociation reaction in an apparatus in accordance with the invention;

FIG. 21 is a schematic block diagram of a high level process for implementing an apparatus and method in accordance with the invention in one alternative embodiment;

FIG. 22 is a schematic block diagram of the energy path for the collection of energy from a source, through dissociation, chemical conversion, and storage of species in order to distribute an energetic material as a fuel or the like;

FIGS. 23 and 24 are a schematic diagrams of alternative embodiments of a filter chamber and reaction chamber for use in assessing and in converting the output from an apparatus in accordance with the invention; and

FIG. 25 is a chart illustrating the status of elements of the apparatus of FIGS. 23 and 24 during various operational stages or steps in accordance with one aspect of the invention.

### DETAILED DESCRIPTION OF THE PREFERRED EMBODIMENTS

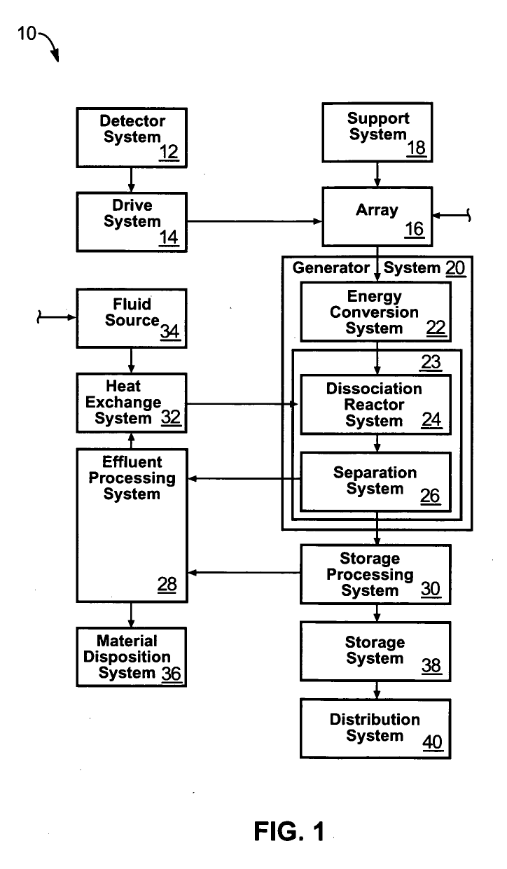

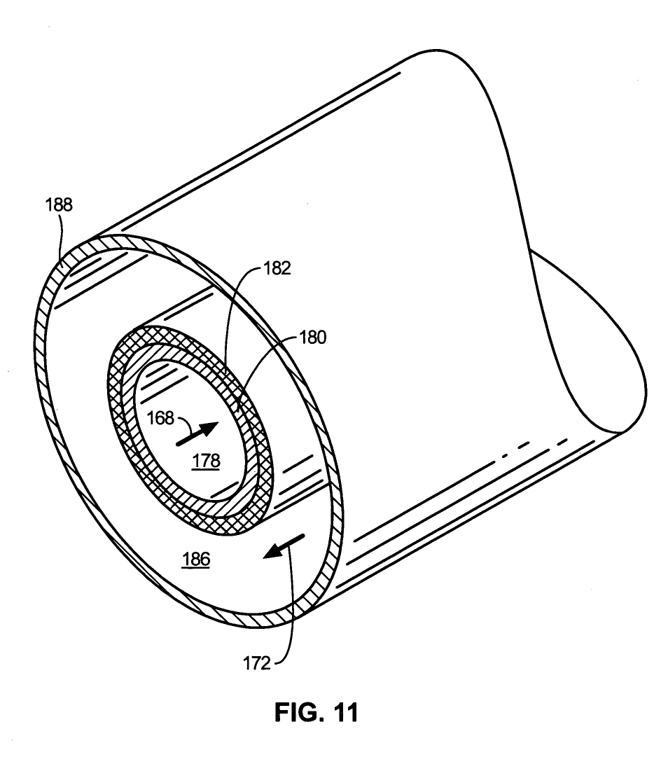

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 23, is not intended to limit the scope of the invention, as claimed, but is merely representative of the presently preferred embodiments of the invention.

The presently preferred embodiments of the invention will be best understood by reference to the drawings, wherein like parts are designated by like numerals throughout.

Referring to FIG. 1, an apparatus, method, and system 10 in accordance with the invention may include a detector system 12 for detecting radiation from the sun, in order to track the sun. A drive system 14 may provide mechanisms to move an array 16, such as an array 16 of mirrors collecting solar energy. A support system 18 may support the array 16 mechanically, as well as providing gimbals, pivots, or the like for moving the array 16 by the drive system 14 in accordance with the tracking processes of the detector system 12.

An array 16 may send energy by way of reflective radiation, for example, to a generator system 20. Typically, a generator system 20 may include an energy conversion system 22. The energy conversion system 22 is responsible for converting the radiant energy received from the array 16, into, for example, thermal energy. It is within contemplation that the energy conversion system 22 may convert the radiant energy into other forms as well, or instead.

A dissociation reactor system 24 may be used in certain embodiments to promote the dissociation of water into its constituents hydrogen and oxygen. The energy provided by the energy conversion system 22 supplies the energy required for dissociation of water molecules. The dissociation reactor system 24 may be catalyzed in order to reduce the threshold level of temperature or energy required to obtain dissociation, recombination of atoms into gas molecules, or both.

Separately from the dissociation reactor system 24, or as part of an integrated mechanism in conjunction therewith, a separation system 26 may separate dissociated hydrogen and oxygen from one another. Typically, a separation system 26 will likewise separate out any excess water (as liquid or vapor) that was originally a feedstock for the dissociation reactions.

Effluents from the separation system 26 may include, for example, water vapor, water liquid, oxygen, and trace gases or minerals. The effluent may pass from the separation system 26 into an effluent processing system 28. The effluent processing system 28 maybe configured in one of several ways. Typically, the effluent processing system 28 will reject both heat and materials, which may be reused. For example, heat introduced into the generator system from the array 16 may be recaptured in order to preheat incoming feedstocks of water or the like. Similarly, the effluent processing system 28 may concentrate waste products, diffuse them, or otherwise handle them appropriately.

A storage processing system 30 receives the generated hydrogen from the separation system 26. A storage processing system 30 may operate on the basis of several physical processes. For example, in one embodiment, the storage processing system 30 may simply dry and compress hydrogen received from the generator system 20. In an alternative embodiment, the storage processing system 30 may include an additional reactor to react the hydrogen into ammonia for storage as a liquid at substantially less pressure and volume than would be occupied by pressurized hydrogen gas.

In yet another alternative embodiment, the storage processing system 30 may involve adsorption of hydrogen onto the multiplicity of surfaces of a crystalline, nanofiber, graphite matrix. In such an embodiment, certain electrical interactions within the atomic structures of the graphite and the hydrogen may provide a strong binding of hydrogen gas to a graphite nanofiber structure providing substantially increased densities at temperatures and pressures comparative with ambient conditions.

With the desired hydrogen product passing to a storage processing system 30, and the remaining effluent passing to the effluent processing system 28, a heat exchange system 32 may be extremely beneficial. A heat exchange system 32 may provide an ability to receive fluids (e.g. incoming water feedstocks for dissociation) from a fluid source 34, adding heat thereto, which has been extracted from the effluent of the generation system 20 or generator system 20.

The heat exchange system 32 may involve multiple heat exchangers in multiple locations throughout the apparatus and system 10 in order to recover and recycle thermal energy having substantial thermodynamic availability. Exposing cooler streams to comparatively warmer streams of material (separated by a wall) may efficiently recover heat from the comparatively warmer stream and incorporate it into the comparatively cooler stream. Whenever the cost of heat exchange equipment is justified and the pressure differentials are acceptable for economical recovery of heat, a heat exchanger may be installed to exchange heat between two mass flows.

Meanwhile, the effluent processing system 28 will discharge materials having insufficient or no economic value. For example, water in excess of that required for generating hydrogen, and not economical to reuse, may be discharged for irrigation or other processes. Alternatively, water may be recycled and joined with water from the fluid source 34 to be introduced into the heat exchange system 32 or into the dissociation reactor system 24 from the material disposition system 36.

Similarly, the oxygen content in the effluent from the separation system 26 may be useful for recovery as oxygen. Nevertheless, if economical use of the oxygen is not forthcoming, the oxygen may be released to a diffusion system, to the atmosphere, to underground seepage systems, or the like.

In one alternative embodiment, a waste disposal system may include waste products including metals and the like, which can be oxidized at an accelerated rate using effluents. In this manner, electricity may actually be generated by oxidation of waste products, using the highly oxygenated water stream available from the effluent processing system 28. Accordingly, a material disposition system 36 may include any, all, a combination, or additional mechanisms for appropriately and economically disposing of effluents in a responsible and cost effective manner.

One advantage of the apparatus and system 10 in accordance with the invention is the generation (actually capture and conversion) of energy, typically in the form of hydrogen or a hydrogen compound. In energy generation or storage, the energy actually originated with a source such as the sun. Energy is simply converted to different forms in order to support safe and economical storage and distribution thereof. Accordingly, a storage system 38 may exist near the generator system 20 in order to economically and immediately store hydrogen or a hydrogen compound for some reasonable or even indefinite period of time.

Typically, a distribution system 40 may involve transportation, intermediate storage, possibly multiple transportation and storage operations, and ultimate delivery to, and use by, a user. A user of energy from a hydrogen source may be a vehicle owner having a fuel-cell-operated engine. That is, for example, an electric car having a fuel cell as an energy source may be refilled with hydrogen in fuel cells.

Alternatively, hydrogen is a very cleanly burning fuel and may be used directly in an internal combustion engine. Alternatively, industrial users of hydrogen may actually use the hydrogen for a process chemical (feedstock), an energy source, or the like. Hydrogen can be burned in furnaces or engines, to run turbines, or fed into reactions as a chemical component to effect numerous industrial processes. It may be used as a feedstock in formulating other energetic compositions, and the like.

If, for example, the storage processing system 30 delivers hydrogen, then hydrogen may be used directly. If the storage processing system 30 delivers a hydrogen compound, such as, for example, ammonia, then the distribution system may include a catalytic cracker in order to recover molecular hydrogen from an ammonia storage medium.

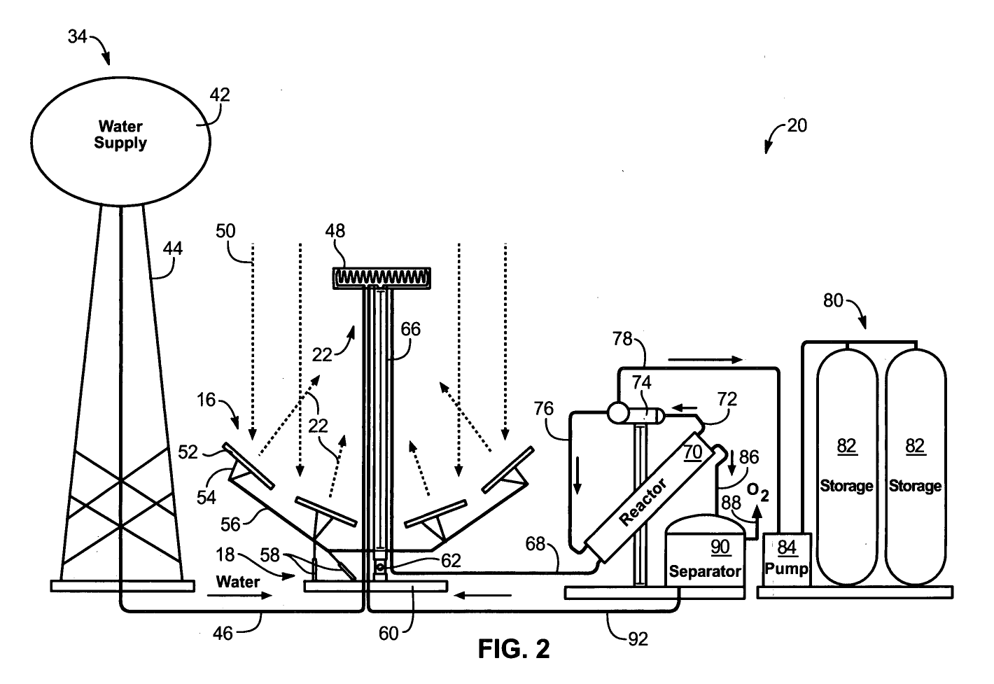

Referring to FIG. 2, one embodiment of an apparatus and method in accordance with the invention may include a fluid source 34 containing a feedstock of water 42. For example, a tower 44 or other structure supporting a tank, or the like, may provide water 42 through a line 46 at ambient conditions. Thus, the waterline 46 maybe considered a relatively cooler or cold water line. The water 42 may be supplied through the line 46 to a collector 48.

A collector 48 may be a solar collector capable of receiving radiation 50 from mirrors 52. A system of mirrors 52 may be supported-on various supports 54 or struts 54 connected to a frame 56. It is within contemplation that the arrays 16 of mirrors 52 may include several hundred mirrors on a single frame 56 all driven by a system of actuators 58 operating the frame 56 in substantially rigid body motion. Accordingly, the relationship between the mirrors 52 and the collector 48 may remain substantially fixed with respect to one another to be aimed at incoming rays.

By contrast, a suitable detector system 12 controls operation of the actuators 58 in order to move the frame 56 with respect to a base 60 thus properly directing the orientation of the array 60 with respect to the incoming rays of radiation 50. Thus, the base 60, while fixed with respect to the earth, for example, may operate with a pivot 62, gimbals 62, or the like in order to properly aim toward the sun to receive radiation 50 and re-reflect that as reflected radiation 64 toward the collector 48.

A collector 48 may be fixed to the frame 56 by supports 66. Accordingly, a line 68 containing heated fluid, typically in the form of hot water or steam, passes the heated water 42 along to a reactor 70.

Steam in the vapor phase has higher volume than water in the liquid phase. The difference between steam and water is not temperature only, but also pressure. Accordingly, the line 68 may contain highly pressurized hot water, saturated steam, or superheated steam. Superheated steam is all vapor, and exists at a temperature higher than the saturation temperature for the pressure at which it exists. Saturated steam is in a state at which the temperature and pressure both correspond to a boiling point of water.

Thermodynamically, the boiling point of water varies with temperature and pressure, and a saturated steam may exist at a broad range of temperatures, and a correspondingly broad range of pressures. In one embodiment, superheated steam may travel in the line 68 in order to provide a complete vapor phase of the water and to provide extra energy to increase efficiencies, accommodate losses, or the like in order to avoid any condensation. Nevertheless, these engineering parameters may be designed into a system 10 at any suitable values in order to provide for efficient and effective operation.

In the illustrated embodiment, the reactor 70 is responsible to dissociate the hot steam into molecular hydrogen and molecular oxygen. Accordingly, an exit line 72 may conduct primarily hydrogen gas. In certain embodiments, a sweep gas (such as nitrogen or water vapor) may carry the hydrogen gas along through the reactor 70 in order to minimize the partial pressure of hydrogen in the reactor 70. In this way, the rate of reaction on the dissociation side of the equation is driven faster. Equilibrium is denied by the continuous and rapid removal of hydrogen from the dissociated side of the equilibrium equation.

The line 72 carrying hydrogen may pass through a dryer 74 or other type of separator in order to purify or isolate the hydrogen from other constituents. The recovered steam, water, or other sweep gas may pass through a line 76 to be recycled through the reactor 70, or otherwise disposed of. Thus, the lines 72, 76 may carry a large amount of water vapor, but may also carry nitrogen gas instead, or in addition thereto.

Meanwhile, the line 78 carries the hydrogen toward a storage system 80 where tanks 82 receive the hydrogen for storage. Again, the pump 84 may include pressurization, cooling, and so forth in order to store the hydrogen appropriately. This may involve pressure and cooling. In one alternative embodiment, the reactor 70 may react the hydrogen after separation from the oxygen, in order that the line 72 may carry not molecular hydrogen, but a molecular composition of hydrogen. In such a mechanism, the storage tanks 82 may contain a liquid compound of hydrogen rather than molecular hydrogen. The pump 84 may be positioned in any suitable place in order to provide the necessary driver 84 to draw, or otherwise move and store the hydrogen, in whatever state or composition it may be.

A line 86 from the reactor 70 may carry the effluent from the main feedstock introduced in the line 68 for disposition. For example, the concentration of molecular oxygen may be discharged or recycled, captured, pressurized, dissipated, or otherwise handled from the line 88. Meanwhile, a separator 90 may be configured in any suitable manner, and operated at the appropriate temperature in order to provide separation of the oxygen from the remaining liquid or vapor stream.

In one embodiment, the separator 90 may simply separate and recycle water as steam, regardless of the state as saturated or superheated, or even as fully condensed water, in order to recover the thermal energy captured therein. Accordingly, a line 92 may carry water in a state of comparatively higher thermal energy to be recycled as water, or simply for extraction of the heat therein. Thus, the line 92 may carry water that will have its heat exchanged with the line 46, or will have its heat or water introduced back into the collector 48.

It has been contemplated that concentrating radiation by 10,000 times may provide a collection efficiency of eighty percent. Water may be dissociated conventionally at temperatures on the order of 2,500°Kelvin under reduced pressures on the order of 0.1 atmospheres, thus dissociating approximately twenty percent of available water. Although the percentage is accurate, a system in accordance with the invention operates below 1,000° C.

Molecular diffusion through a porous wall may provide certain advantages such as an increased mass flow rate even at low pressures. For example, Knudsen flow provides that the diffusion flow rate in moles per second is related to the radius (r) and the length (L) of a tube, as well as a pressure difference (p), a molecular weight (M) of the diffusing gas, and the universal gas constant (R).

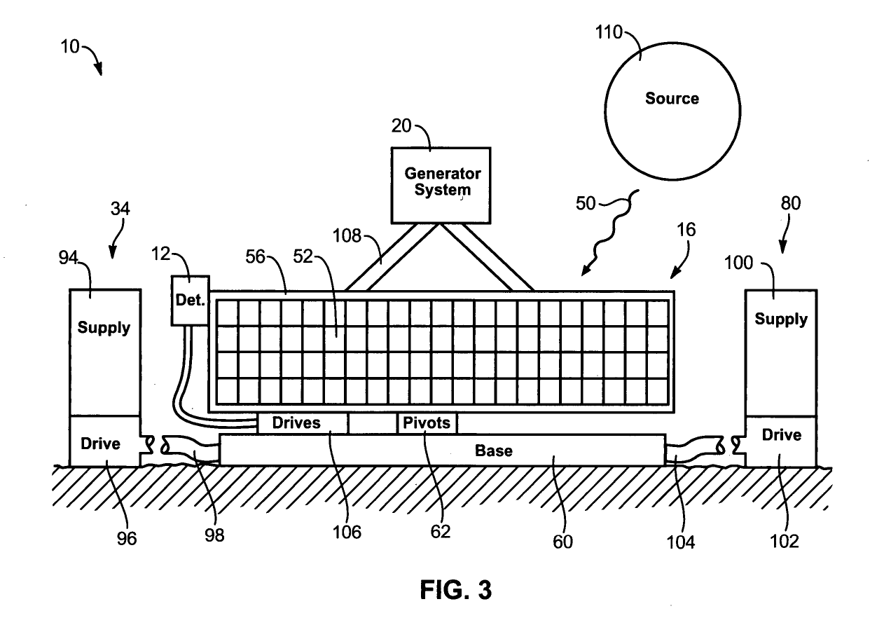

Referring to FIG. 3, a schematic of one embodiment of an apparatus, method, and system 10 in accordance with the invention may be thought of as containing a fluid source 34. The fluid source 34 may include a supply 94 or tank 94 associated with a drive 96 to supply water through a line 98 or otherwise ultimately feeding the generator system 20. Similarly, as an output of the generator system 20, hydrogen or a hydrogen compound maybe passed from the generator system 20 through a line 104 to a storage tank 100 of a storage system 80.

Similarly, a drive 102 may provide a mechanism for pressurizing, moving, or otherwise motivating the energetic compound (e.g. hydrogen, ammonia, etc.) into the storage tank 100. Meanwhile, in the schematic embodiment of FIG. 3, a system of connections, such as slip rings, flexible lines, insulated lines, and the like may actually pass fluids (liquids and gases) to and from the generator system 20 using as protection or support part or all of the base 60, array frame 56, and supports 108 or struts 108 supporting the generator system 20.

In the embodiment of FIG. 3, the entire generator system 20 may actually be supported by the frame 56 that supports the array to move with the array 16. For example, a system of flexible lines and slip rings may provide sufficient motion, properly referred to as relative motion, between the base 60 and the frame 56. Pivots 62, whether single, double, or triple, and whether simple pivots, gimbals, or the like may support the frame 56 with respect to the base 60 in order to provide relative motion therebetween in one, two, or even three dimensions. For most practical matters, azimuth and elevation are the only dimensions of motion or degrees of freedom actually needed for a tracking solar collector array 52.

Nevertheless, by whichever means, a detector system 12 may provide information in control data for controlling the drives 106 urging motion between the frame 56 and array of mirrors 52 with respect to the base 60. Thus, the array 16 may track the sun in order to improve the projected area of the mirrors 52 in the array 16 presented to the solar source of energy. Accordingly, radiation 50 from the sun 110 is reflected into the generator system 20.

The generator system 20 may then include a conversion system 22 to convert the radiant energy 50 into thermal energy, as well as a dissociation reactor 24 and separation system 26. Accordingly, the line 104 may carry either hydrogen, or even a chemical composition of hydrogen such as ammonia, to the storage tank 100. In the schematic embodiment of FIG. 3, the storage processing system 30 may actually be incorporated into the generator system 20.

Various difficulties arise in the chemical and mechanical stability of materials. In certain embodiments, a single barrier catalyzed to enhance dissociation on one side of a wall thereof may be catalyzed on the opposite side of the wall to promote formation of ammonia from the hydrogen. Nevertheless, experience has shown that some catalysts, and some organic membranes may require lower operating temperatures than the most efficient operating temperatures for dissociation. Accordingly, the reactions or reactors that may form part of a storage processing system 30 may be isolated from the generator system 20 that provides higher temperature dissociation.

In prior art systems, dissociation occurs at 2,000° C. to 3,500° C. It has been found that dissociation can occur between the temperatures of 400° C. and 900° C. at sufficiently effective and efficient rates to make an economically viable system 10. Meanwhile, it has been found that the ammonia generation reactions can occur effectively in the range of 400° C. to 600° C. Nevertheless, above 500° C. some catalysts have been found to be easily poisoned or otherwise rendered ineffective. Accordingly, in one embodiment, the catalyst for generation of ammonia from hydrogen may be operated in a comparatively cooler environment than the catalyst designated for promoted dissociation of water into hydrogen and oxygen.

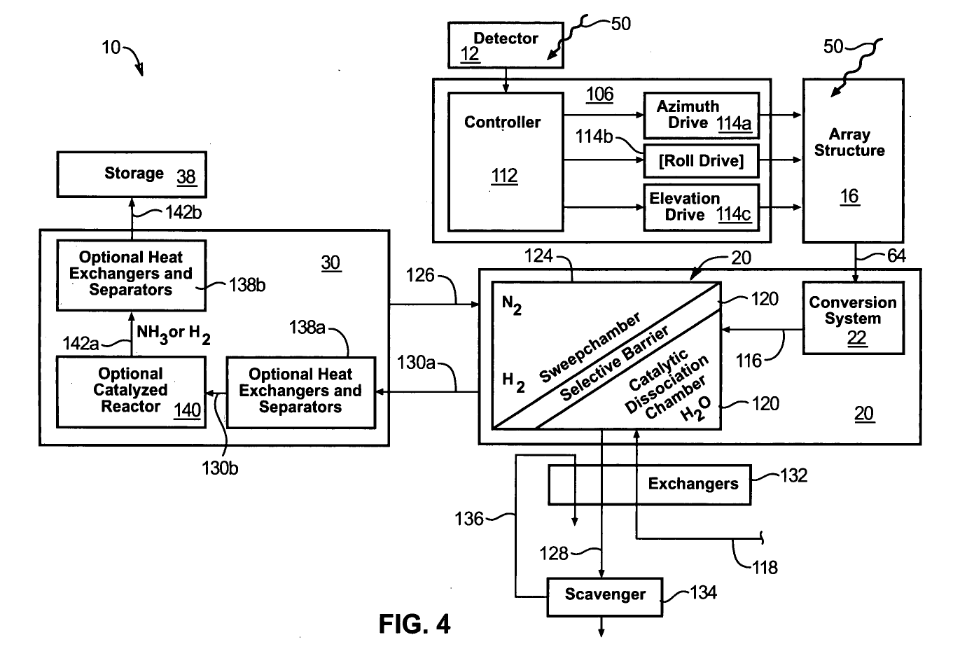

Referring to FIG. 4, in one embodiment, an apparatus, method, and system 10 in accordance with the invention may operate by radiation 50 impinging upon a detector system 12, and an array structure 16. The detector 12 may provide information to a controller 112 as part of a system of drives 106. The drives may include various motors 114 for azimuth, elevation, and possibly roll. These represent in independent, or even mutually orthogonal axes of rotation. As a practical matter, an azimuth drive motor 114a, a roll drive motor 114b, and an elevation drive motor 114c may be large or small depending on the degree of balance and equilibration provided for the array structure 16. For example, a fully gimbaled system may require a minimum of power. Alternatively, highly cantilevered or leveraged system may require substantial energy for the output of the motors 114.

Alternatively, a controller 112 may include a real time clock capable of representing the time of day and day of the year such that correct azimuth and elevation of the array 16 may be calculated based on latitude, longitude, and orientation of the base 60. In this instance, a detector 12 may be used simply to determine cloud cover, intensity, and other factors related to solar radiation intensity in order to anticipate operational parameters for the reactor 70 and collector 48.

Ultimately, the array structure 16 directs radiation 50 as redirected radiation 64 into a conversion system 22. The conversion system 22 is part of a generator system 20, which may or may not include other heat exchange systems, scavengers, and the like.

The conversion system 22 provides heat 116 or thermal energy 116. Meanwhile, a line 118 introducing water, either as liquid or vapor, converges with the heat 116 in a chamber 120 for dissociation of water. Typically, dissociation will occur by catalysis along a selective barrier 122. In one presently contemplated embodiment, a selectively permeable barrier 122 may be treated with a catalyst on one or both surfaces thereof. Accordingly, water may catalytically dissociate, in view of the substantial energy input from the heat 116 to generate hydrogen and oxygen in the chamber 120. Typically, on the order often to twenty percent of the water may be dissociated in the chamber 120.

Immediately upon dissociation, hydrogen at the catalytic surface of the selective barrier 122 may immediately migrate through the selectively permeably barrier 122 to pass into a sweep chamber 124. Typically, the sweep chamber 124 is swept or purged by a sweep gas 126 such as nitrogen. Water vapor may also be used, or may be used instead. Nevertheless, the use of nitrogen provides an advantage if optional reactions with nitrogen are desired in order to produce an ammonia compound for higher density storage at more modest pressures and temperatures.

Nevertheless, the partial pressure of hydrogen in the sweep chamber is maintained as low as necessary to be effective to maintain a rapid and substantially instantaneous removal of dissociated hydrogen from the dissociation chamber 120. Accordingly, by LeChatelier's principle the dissociation chamber 120 operates proximate the selectively permeable barrier 122 to drive the equilibrium of the dissociation reaction toward the dissociated species by maintaining a low partial pressure of hydrogen, particularly through the introduction of a sweep gas 126, and has been found to greatly increase the reaction rate and passage of hydrogen into the sweep chamber 124.

Meanwhile, the effluent 128 or the water that has not dissociated into molecular hydrogen and oxygen may pass through the line 128 to facilitate recapture of thermal energy therefrom. For example, a certain amount of the energy introduced as heat 116 has been captured in the chemistry of dissociated species including the hydrogen passing out through the line 130. Meanwhile, the sensible heat in the hydrogen flow and in the associated sweep gas 126 will pass with the species in the line 130. By the same token, thermal energy will pass in the line 128 with the oxygen and water discharged from the dissociation chamber 120.

A heat exchanger 132 may exchange energy from the effluent line 128 into the incoming line 118. Heat thus exchanged is thus preheating, or even boiling and vaporizing, the incoming water in the line 118.

A scavenger 134 may be thought of as a scavenger, filter, absorber, adsorber, reactor, or anything that may tend to remove undesired constituents from the effluent 128. For example, if oxygen is reacted out, separated out, or otherwise removed from the effluent line 128, then the water may be introduced back into the feed line 118. In an alternative embodiment, oxygen may be burned or reacted in the scavenger 134, producing additional heat in the water. The heat may be exchanged again through the exchanger 132 from the line 136, carrying the heater water, back into the incoming (cool) line 118. Moreover, the scavenger 134 may also react with hydrogen that has been swept from the dissociation chamber 120, recombining the hydrogen with oxygen to produce heat, and thus remove both the reactive species, and provide for recycling of the heat generated thereby.

In one alternative embodiment, a storage processing system 30 may optionally include various components. For example, optional heat exchangers 138a, 138b may recover heat from the fluids in the line 130. In certain embodiments, the heat exchanger 138a may serve to reduce the temperature of the fluid in the hotter line 130a compared with the temperature in the cooler line 130b. Accordingly, a reactor 140 may then operate at a lower temperature. In certain embodiments, catalysts have been found to poison or otherwise become ineffective at temperatures on the order of 600° C., and apparently as low as 500° C. Thus, a catalyzed reactor 140, which may be optional, may serve to combine hydrogen into ammonia. It may operate at a lower temperature than that of the dissociation chamber 120, selectively permeable barrier 122, and sweep chamber 124. Nevertheless, the optional catalyzed reactor 140 may be embodied in a catalytic surface on the selective barrier 122 in the sweep chamber 124 itself.

By whatever mode, the hydrogen may be prepared for introduction into a storage system 38 by the storage processing system 30. Heat from the heat exchangers 138a, 138b may be recycled into the incoming line 118, or other locations in the system 10 in order to recover and use the heat therefrom. In one embodiment, the heat exchangers 138a, 138b may be sufficient to adequately cool process gases. Alternatively, the reactor 140 may be replaced by a compressor to compress hydrogen gas directly. However, in one currently contemplated embodiment, the entire storage processing system 30 may involve a combination of heat exchange, selective pressurization, and reaction of hydrogen into a hydrogen compound suitable for placement in storage systems 38 to ultimately be distributed.

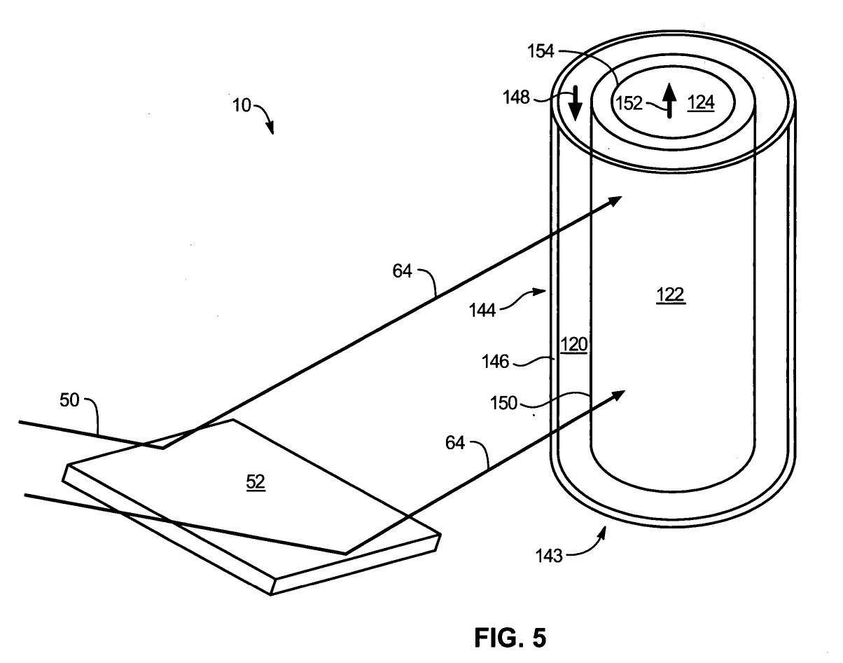

Referring to FIG. 5, certain embodiments of components of the system 10 are shown along with the interactions therebetween. For example, radiation 50 impinging on a reflector 52 or mirror 52 may cause reradiated radiation 64, having no substantial change in wavelength, toward a collector core 143. The collector core 143 may be a part of a collector 48 in one of the various configurations available.

In the illustrated embodiment, a convection shell 144 (e.g. window) permits passage of the radiation 64 toward the permeable barrier 122. The permeable barrier, selective barrier, or semi-permeable, or selectively permeable barrier 122 effectively passes selectively the hydrogen into the chamber 124. In some embodiments, the permeable barrier 122 may be not permeable, and may simply be a material barrier in order to pass heat into the chamber 124. This would relegate the collector core 143 into a simple solar energy collector converting radiation 64 into heat at the barrier 122, to be transferred by convection into the flow 152 through the chamber 124.

Typically, a wall 146 of the convection shell 144 may be transparent to the radiation 64 at the frequencies thereof. Accordingly, a water flow 148 through the chamber 120 may absorb some of the radiation 64, but allow much of it to pass through to the barrier 122. The barrier 122 typically absorbs the radiant energy 64, converting it to thermal energy that can be convected back from the barrier 122 into the water flow 148 in the chamber 120.

Typically, the surface 150 of the barrier 122 is a catalyzed surface promoting dissociation of the water flow 148 into its constituent oxygen and hydrogen. Accordingly, the flow 152 in such an embodiment is or contains hydrogen dissociated out of the water flow 148. Optionally, the surface 154 on the inner diameter of the barrier 122 may also be a catalyzed surface promoting catalytic conversion of the hydrogen from the flow 152 into ammonia.

For example, if the flow 152 includes a sweep gas 126 comprising nitrogen, and the temperatures are appropriate with a catalytic surface 154, then hydrogen passing through the semi-permeable barrier 122 into the chamber 124 may react at a particularly suitable threshold energy level, or a substantial fraction may react when energized to the appropriate threshold level, such that catalysis on the catalytic surface 154 may provide a very high reaction rate or sufficiently high reaction rate to convert substantially all of the hydrogen in the flow 152 into ammonia.

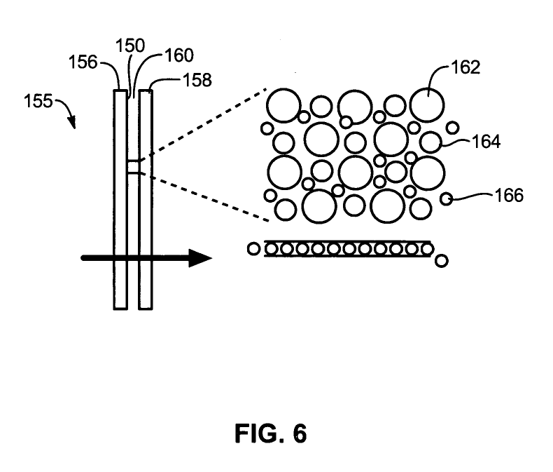

Referring to FIG. 6, a semi-permeable barrier 122 in certain embodiments may be a proton conductor. Chemical and diffusion processes may be completely adequate through semi-permeable barriers 122. In certain embodiments, the catalyzed reactor 140 or some other semi-permeable barriers 122 may be formed as proton conductors. In such an embodiment, a wall may include a conductive mesh 156, 158 sandwiching a catalytic surface 152 and barrier membrane 160 therebetween. Electrical potential applied to the layers 156, 158 of conductive mesh, may provide an electrical drive potential for electrophoresis or electrically driven migration of certain species.

For example, in the illustrated schematic, a large multiply charged anion 162 may form the principal structure of a matrix, interspersed with certain comparatively large singly charged cations 164. In this matrix of large anions 162 and comparatively large cations 164, the comparatively small hydrogen ions 166 or protons 166 may pass through the barrier 155.

One of the benefits of an apparatus in accordance with FIG. 6 is the driving potential of electrophoresis, which can be substantial. Nevertheless, in experimental systems in accordance with the invention, the concentration-driven migration of hydrogen through a semi-permeable barrier 122 of porous ceramic has been found to provide practical efficiencies for production, separation, and collection of hydrogen.

To the extent that certain materials exist as glasses, such as a potassium hydrodisilicate in an amorphous structure as a proton conductor, electrolytically such a material becomes conductive near its softening point. Crystalline materials for conduction of protons tend to have a comparatively low conducting capacity. Oxometallates of the transition metals are used to increase proton conducting capacity, including titanates vanadates, chromates, zirconates, niobates, molybdates, hafnates, tantalates, and wolframates. Thus, the potassium hydrodisilicate glasses, doped with aluminum ions or other metals, such as boron ions or the oxometallates improve permeability and reduce operating temperatures.

A proton conducting membrane may operate to split water into hydrogen and oxygen. Proton conductors may include a lanthanide element, barium, strontium, or combinations thereof. Certain proton conductors include yttrium. A second phase material may include platinum, palladium, nickel, cobalt, chromium, manganese, vanadium, silver, gold, copper, rhodium, ruthenium, niobium, zirconium, tantalum, and combinations of these. Current membrane systems, require large pressure drops and gas recompression. Polymeric membranes require comparatively low temperature processes and in general separation by polymeric proton membrane filtration has not been deemed to yield industrially significant hydrogen flow in the prior art.

Conventional cation and proton conducting membranes typically comprise a sheet of homogeneous polymer, a laminated sheet of similar polymers, or a blend of polymers. These are typically homogenous polymers. Some are blends. Some polymers, such as the perfluorosulfonic acids (PFSA) are solid organic super-acids, which rely on sulfonate functionality as a stationary countercharge for the mobile cations. Typically, monovalent, cations may include hydrogen. One PFSA material is NAFION™ requiring water for conductivity. One proposal includes a cation-conducting composite membrane including an oxidation resistant polymeric matrix filled with inorganic oxide particles. Synthetic organic polymers may include PFSA, polytetrafluoroethylene, perfluoroalkoxy derivatives of PTFE, polysulfone, polymethylmethacrylate silicone rubber, sulfonated styrene-butadiene copolymers, polychlorotrifluoroethylene (PCTFE), and others such as FEP, ECTFE, PVDF, ETFE, and so forth. Such a film relies on particle-to-particle contacts in order to produce a Gurley number greater than 10,000 seconds.

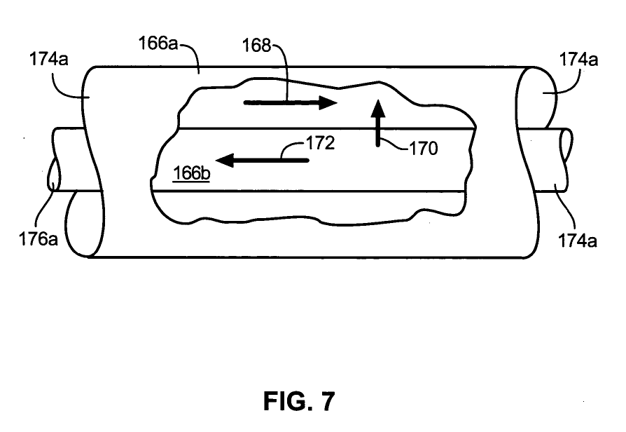

Referring to FIG. 7, one embodiment of a counter flow heat exchanging mechanism may include a conduit 166a placed within or around a second conduit 166b. Accordingly, a flow of water 168 passes through the conduit 166a but not through the conduit 166b, as illustrated. Were the conduit 166a to be within the conduit 166b, the roles thereof being reversed, then the water flow 168 would still be subject to a barrier separating it from the contents of the conduit 166b.

Nevertheless, a heat flux 170 passes from the flow 172 in the conduit 166b into the flow 168 of the conduit 166a. The inlet 174a of the conduit 166a introduces the comparatively cooler flow 168. Meanwhile, the inlet 174b of the conduit 166b introduces a comparatively hot flow 172. The flow 172 may typically include the water and oxygen effluent and may optionally include any sweep gas from a dissociation chamber 120, for example.

Likewise, the outlet 176a of the conduit 166a yields a comparatively hotter flow 168 by virtue of the heat 170 added thereto. Accordingly, the outlet 176b of the conduit 166b discharges a comparatively cooler flow 172 by virtue of the heat 170 lost from the flow 172. By counter flow heat exchange, the hottest states of the flows 168, 172 are exposed to one another thermally while the comparatively coolest states of the flows 168, 172 are likewise exposed to one another. This results in very efficient heat transfer, and in the ability to capture the maximum amount of energy, and maintain the maximum temperature potential between the flows 168, 172 for driving heat exchange.

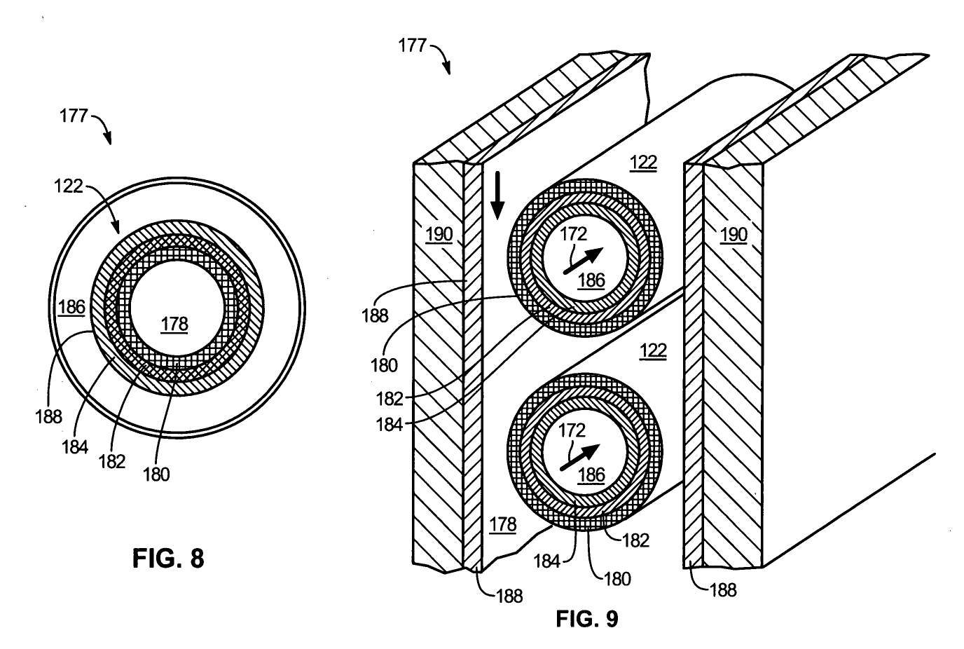

Referring to FIGS. 8-9, while continuing to refer generally to FIGS. 1-7, an integrated combination 177 of a dissociation reactor 24, separation system 26, and storage processing system 30 is illustrated. As a practical matter, additional storage processing 30 may be required in order to cool and pressurize certain materials. For example, hydrogen may require comparatively extreme compression and associated cooling. Ammonia may require modest elevated pressure over ambient in order to maintain it in a stable anhydrous state.

In the embodiment of FIG. 8, a steam line 178 may conduct water vapor in a superheated or saturated state to contact a catalyzed region 180 of a barrier 122. The barrier may be a single material, such as a semi-permeable ceramic built with catalysts embedded therein or coated thereon. Alternatively, the barrier 122 maybe built up from multiple layers of different materials. In one embodiment, the catalyzed region 180 may be built with a suitable catalyst embedded or thinly coated with a suitable catalyst (and nanopore ceramic layer) on a semi-permeable barrier 122 in order to catalyze the dissociation of steam into its constituent oxygen and hydrogen.

Meanwhile, the transport region 182 may have an effective diameter of porosity larger than the diameter of hydrogen, but less than the diameter of oxygen, to pass the hydrogen species through the barrier 122 toward the catalyzed region 184. The catalyzed region 184 may be provided with a catalyst suitable for generating ammonia from hydrogen and nitrogen in the line 186 or passage 186. Thus, the passage 186 may carry nitrogen as a sweep gas 126 and hydrogen as a dissociated byproduct of catalysis from the steam line 178 or steam chamber 178, which constituent nitrogen and hydrogen will ultimately be converted in substantial measure. Substantially all of the hydrogen passed through the a barrier 122 will convert into ammonia. To reduce resistance to flow, the barrier region 182 may have larger micropores while the catalytic region 180 has nanopores.

A containment wall 188 may complete the containment of the ammonia flow in the chamber 186 or conduit 186. In the configuration of FIG. 8, flows in the lines 178, 186 may be concurrent or countercurrent. Nevertheless, obtaining the maximum effective temperature differential between the lines 178, 186 may be better promoted by a countercurrent flow.

Ammonia is a suitable hydrogen carrier, each molecule containing one nitrogen atom and three hydrogen atoms. Ammonia is generally considered nonflammable, is easily handled in liquid anhydrous form, and does not require expensive and complicated sealing technology or complicated refrigeration technology. Ammonia contains 1.7 times as much hydrogen as liquid hydrogen at a given volume.

Therefore, ammonia offers significant advantages as a vehicle fuel due to the high density. Such densities in hydrogen could typically be achieved only at very low cryogenic temperatures. Facilities for storage and transport of ammonia are available throughout the world. Moreover, comparatively small ammonia crackers are available. Ammonia cracking is endothermic, resulting in a certain loss of efficiency, but provides more fuel capacity per weight than methanol. Turbines and other engines can be tuned to directly crack and combust ammonia as a major fuel component, reducing the need for an external or previous cracking operation.

Dissociation rates depend on temperature, pressure, and catalysts, just as many chemical reactions do. Nevertheless, temperatures on the order of 900° C. operate suitably, and alkaline fuel cells are insensitive to small amounts of trace ammonia. Therefore, a cracking process may be comparatively efficient, and still not poison a fuel cell in which the hydrogen is used.

Nickel oxide and aluminum oxide are base materials for suitable catalysts to crack ammonia. The addition of noble metals like platinum, rhodium, palladium, lanthanum oxide, and ruthenium may be added alone, or in combination. Some excellent results are reported using ruthenium salts added to a nickel oxide catalyst. Thus, it is contemplated that materials that are more or less commercially available may be used to construct a hydrogen regeneration plant using ammonia as a feedstock. Thus, transport and storage of hydrogen itself may not be required. In the case of alkaline fuel cells, a particularly high efficiency is contemplated since the hydrogen need not be excessively pure, and such a fuel cell can tolerate small amounts of ammonia in the hydrogen fuel. Ammonia fuel cells are also contemplated.

In the embodiment of FIG. 9, a crosscurrent flow in a bank of barriers 122 may include steam in a passage 178 passing over the barriers 122 in crossflow. This provides a fully integrated reactor at the barrier 122, with resulting ammonia traveling out through conduits 186. In the embodiment of FIG. 9, the locations of ammonia and steam may be reversed. Accordingly, the catalytic surfaces 180, 184, or the catalyzed regions 180, 184 may each be associated with their respective flows as illustrated in FIG. 8.

In addition, an insulating layer 190 may be added to the embodiment of FIG. 9, or the embodiment of FIG. 8. Insulation 190 provides a resistance to the discharge of heat into the environment, further promoting a complete exchange of thermal energy between the respective chambers 178, 186. Thus the combinations 177 provide simplified structure, heat transfer, and chemistry.

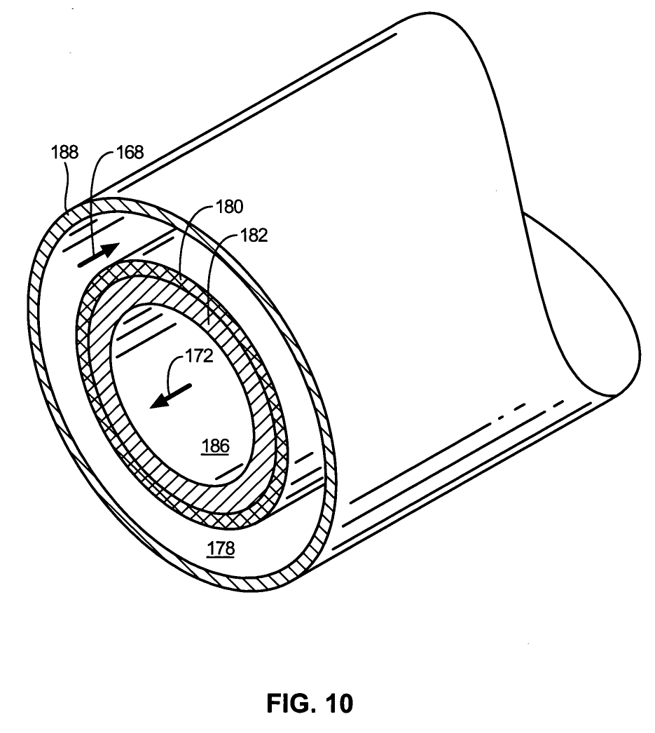

Referring to FIGS. 10-14, while continuing to refer generally to FIGS. 1-9, a flow 168 of water vapor (steam) may travel through a passage 178 in contact with a catalytic material 180 or catalytically impregnated matrix such as a semi-porous ceramic. The flow 168 may be contained by a wall 188. If a comparatively high pressure is maintained in the passage 178, then a ceramic may prove structurally adequate, being loaded in compression, and very effective for the semi-permeable barrier 182. Accordingly, the migration of hydrogen, once dissociated from oxygen in the passage 178, may then pass under the influence of both pressure and the concentration gradient of hydrogen, to both advance the reaction and carry away the hydrogen species.

The passage 186 may operate at a comparatively lower pressure than the chamber 178, as a flow 172 of hydrogen and possibly a sweep gas or vapor flows therein. By contrast, if the comparatively higher pressure exists inside a passage 178 surrounded by the chamber 186, then ceramics may lack the right balance of costs, strength, size, and porosity. An improved structure as well as a possibly thinner barrier 182 may result if a catalyst 180 is plated on, or provided interior to, the barrier wall 182. In such a way, a material such as a metal may be used as the barrier 182, providing a suitable porosity.

In some embodiments, the catalyst 180 may have a porosity sufficient to exclude species other than hydrogen from passing therethrough. In such an event, the barrier 182 may need only be a highly porous mechanical support structure. Thus, the structural barrier 182 may be a porous material coated with a catalyst 180, or may be a widely porous and structural material relying on a catalytic layer 180 to provide the separation of hydrogen from the main flow 168 of water vapor containing the dissociated oxygen.

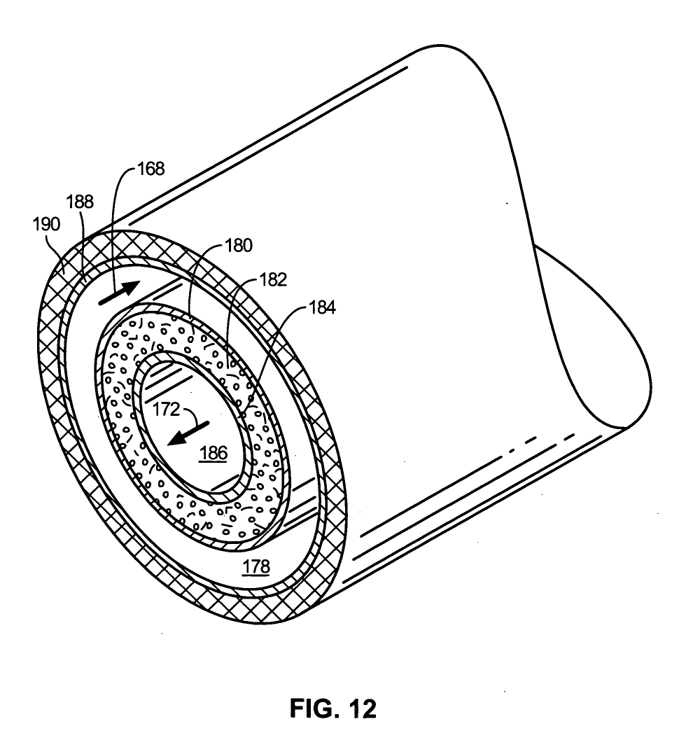

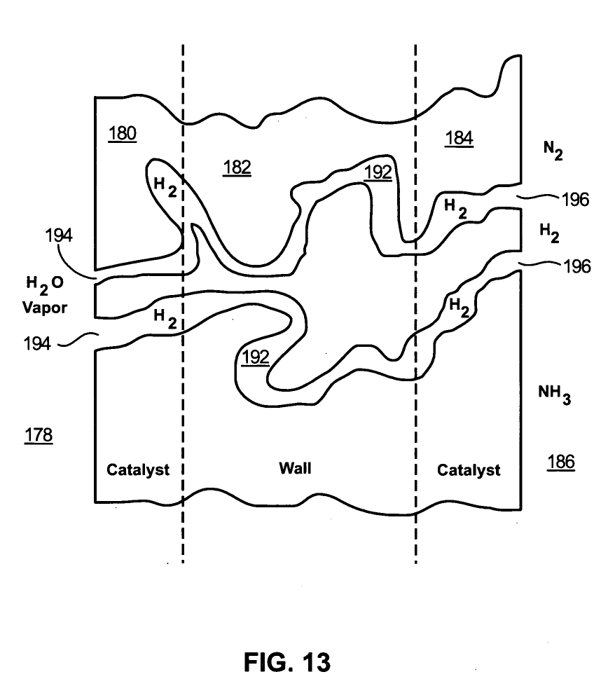

Referring to FIGS. 12-13, the barrier material 182 may contain numerous tortuous passages constituting the “porosity” thereof. A ceramic may structurally look like an open cell sponge, or solidified sand, or other very porous solid. The interstitial spaces operate as passages to “filter” out all but the suitably small particles, such as hydrogen.

Similarly, a second catalytic layer 184 may exist opposite the first catalytic layer 180 with respect to the semi-permeable barrier 182. It is entirely appropriate that the catalytic layer 180 may itself provide the semi-permeable feature allowing the passage of hydrogen to the exclusion of oxygen and water.

Alternatively, the catalytic layer 180 may actually be impregnated into or deposited as a film on the passages of the semi-permeable material 182. As illustrated in FIG. 13, schematically, each passage 192 may have an entrance 194 on the water vapor side or passage 178, and an exit 196 on the hydrogen or swept side, in the passage 186. Schematically, the paths are shown as tortuous paths having multiple dimensions. As a practical matter, the paths may not be paths at all but may be simply a completely porous material (e.g. analogous to packed sand or sponge as noted above) having interstices of some mean effective or minimum effective diameter capable of passing only particles the size of hydrogen molecules therethrough.

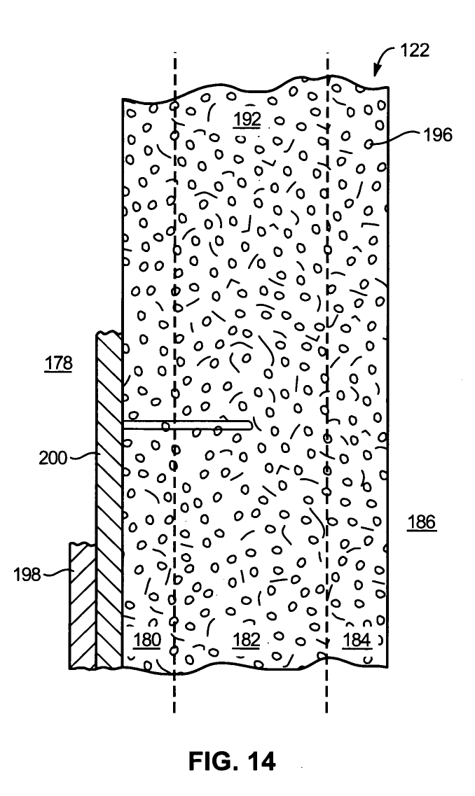

For example, two hydrogen molecules might never take the same exact path through the wall 182. The effective path may branch so often as to render statistically impossible the prospect that two molecules would travel the exact same path. Similarly, the catalytic layers 180, 184 may actually be better characterized as portions of the wall 182 in which catalyst has been plated over the surfaces of the passages 192 and the principal exterior surfaces 195. Referring to FIG. 14, an alternative embodiment of the reactor systems of FIGS. 8-13 may include various options. The embodiment of FIG. 14 actually includes multiple options that may be used individually or in combination. For example, in one embodiment, a catalytic surface 198 or catalytic layer 198 may stand substantially alone. The layer 198 of a catalyst may actually be highly porous and not serve as a limiting or filtering barrier to the passage of reactants.

Alternatively, a carbon nanofiber layer 200 may be used as the catalytic layer 198 instead of the catalytic layer 198, or in combination with the catalytic layer 198. Since a nanofiber layer 200 tends to adsorb gasses rapidly, a nanofiber 200 may act as a filter as well as a collector, permitting passage only of hydrogen, and accumulating hydrogen from the chamber 178, or passage 178. The affinity of carbon nanofibers 200 for hydrogen may act as an effective “magnet” drawing hydrogen out of the chamber 178 of other reactants, oxygen, and residual water vapor remaining.

In yet another embodiment, the nanofiber layer 200, or nanotube layer 200 grown onto a surface, may exist as a separation barrier, resulting in a very high concentration of hydrogen providing a substantial partial pressure differentiation between the nanofiber layer 200 and the separated hydrogen chamber 186 or passage 186. Of course, a sweep gas in the passage 186 may continue to move hydrogen away from the porous wall 182, thus driving equilibrium toward the production of more hydrogen in the passage 178.

An alternative embodiment may include a barrier 122 having a tortuous maze of passages 192 presenting a number of inlets 194 to the reactant chamber 178. Some corresponding or otherwise related number of outlets 196 pass into the hydrogen chamber 186. The catalyst region 180 and catalyst region 184 are optional, may be used in combination with other catalysts 198, may be used alone, or either one may be included or left out.

Metal catalyzed decomposition of certain hydrocarbons in the temperature range from about 400° to 800° C. results in a fibrous carbon material. The carbon forms graphite platelets perfectly arranged in various orientations with respect to the fiber axis. These small “nanofibers” form in various configurations. A significant feature is the presence of a large number of edges, which constitute sites readily available for chemical or physical interaction. These are particularly useful for adsorption. For example, these crystalline solids can exhibit surface areas on the order of 300 to 700 square meters per gram with the total surface area chemically active. Typically, carbon nanofibers vary from five to 100 microns in length and are between five and 100 nanometers in diameter.

It is possible to tailor the morphological characteristics, the degree of crystal entity, and the orientation of the precipitated graphite with respect to the fiber axis. Typical graphite layers are separated by distance of 0.34 nanometers, although the spacing may be increased. It is contemplated that such graphite structures may be fabricated at approximately one-tenth the commercial price of graphite.

A high mechanical strength may support use of these graphite materials in liquid phase reactions where vigorous agitation might otherwise breakdown other structures. In particular, such graphite structures may provide excellent and strong adsorbates. Nanofiber structures may provide a practical storage system for gases.

For example, it has been shown that when such structures are pretreated whereby all adsorbed and absorbed gases are eliminated, then on subsequent exposure to hydrogen and moderate pressures, they are capable of absorbing and retaining up to thirty liters of molecular hydrogen per gram of carbon at room temperature. They have also demonstrated an ability to release the gas at moderate temperatures.

Although theoretical calculations indicate storage of 6.2 liters of molecular hydrogen per gram, as a single flat layer, experimental determinations have shown that the actual absorption capacity far exceeds that of the theoretical value. Accordingly, it appears that one could transport molecular hydrogen in a liquid-like state without refrigeration or the volume weight associated with compressed gas.

The interlayer spacing is approximately 3.4 angstroms, sufficiently large to permit molecular hydrogen at a kinetic diameter of 2.9 angstroms, yet restrictive against oxygen and nitrogen which are too large. Nanotubes provide similar sizes of porosity and structures as well as adsorption characteristics. A process called “chemisorption” tends to provide a quasi electronic bonding such that hydrogen can be strongly held at room temperature, thus eliminating any need for cryogenic conditions. The process of chemisorption is reversible likewise at room temperature with a reduction in pressure.

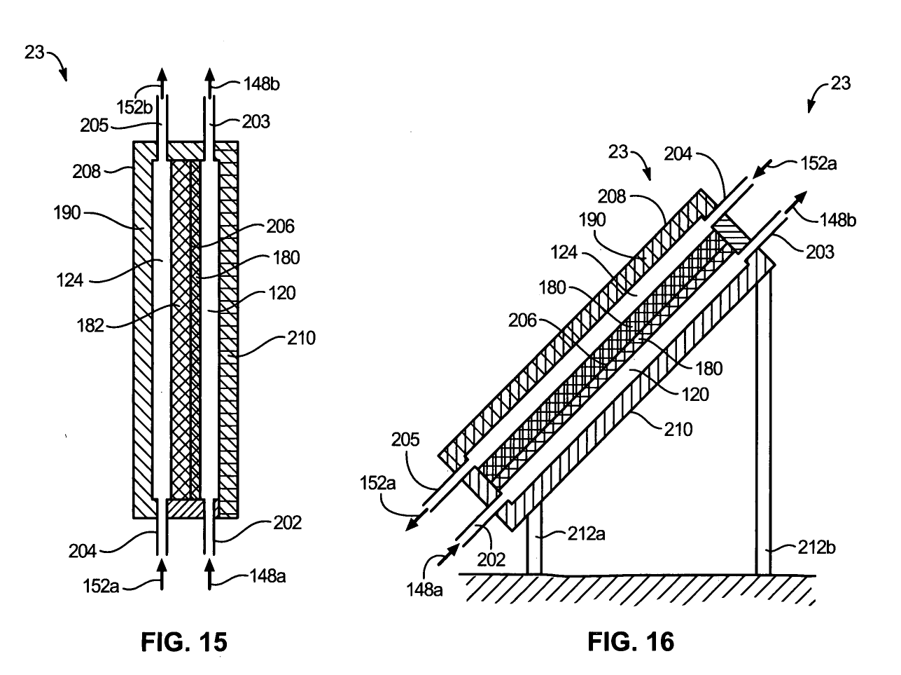

Referring to FIGS. 15-19, while continuing to refer generally to FIGS. 1-14, various configurations of hydrogen generators 20 may exist. In particular, the energy conversion system 22 may or may not be integrated with the dissociation reactor system 24 and the separation system 26. Typically, an inlet 202 permits introduction of water or water vapor moving toward an outlet 203. Similarly, an inlet 204 for a sweep gas (optionally) may provide for flow toward a corresponding outlet 205. Meanwhile, each of the passages 120, 124 carrying the water vapor and sweep gases, respectively, may be divided by a barrier 182 provided with a catalytic region 180 for promoting dissociation of water.

As an economic measure, the catalytic region may or may not extend throughout the entire transport region 182 or semi-permeable “membrane” 182. Accordingly, a boundary 208 may exist after which the catalytic region 180 may cease. In fact, the catalytic region 180 may be made of a separate material. Nevertheless, in one presently contemplated embodiment, the catalytic region 180 is merely an impregnated or coated region of the underlying barrier 182 or semi-permeable member 182.

Insulation 190 may maintain temperature and reduce thermal energy losses. Likewise, a layer 210 may represent the incoming energy boundary. For example, energy may arrive by various means, including transport by conduction, convection, or the like. In one embodiment, the layer 210 may actually be an absorption layer impinged by solar radiation. Accordingly, the passage 120 experiences a thermal (heat) load from the absorptive wall 210 in such an embodiment.

Referring to FIG. 16, the reactor 23 may be inclined and the direction of the flows 148, 152 may be concurrent flows or countercurrent flows. In the embodiment of FIG. 16, the flows 148, 152 run countercurrent to one another. Supports 212 provide for a different orientation exposing the energy layer 210, for example to reflected solar radiation from the array 16.

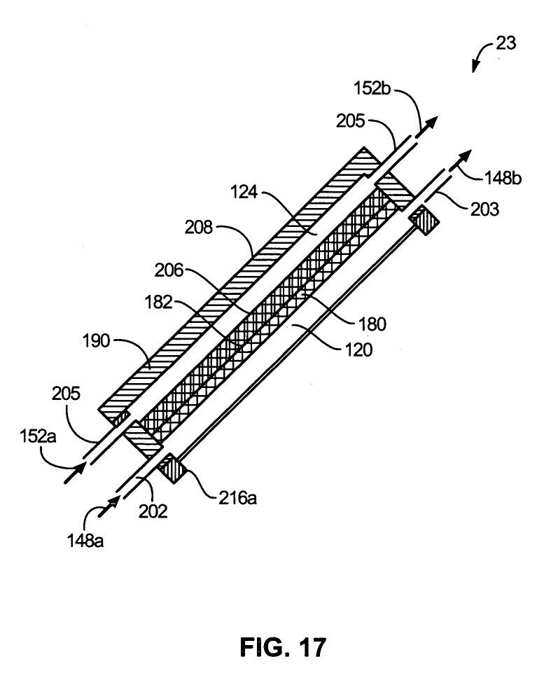

Referring to FIG. 17, the chamber 120 may actually be embodied in a plate or cylindrical configuration in which the layer 210 is replaced by a window 214, rendering, for example, the catalytic surface 180 or the catalytic region 180 the actual collector. Thus, the catalytic surface 180 may convect energy back to the water vapor in the chamber 120 to extract the species of hydrogen from the dissociated water vapor flow 148. Suitable structure 216, may include framing, mounts, struts, and the like to fix the reactor 23 with respect to the array 16 in order to properly impinge light upon the catalytic region 180 “under,” behind, or otherwise beyond the window 214.

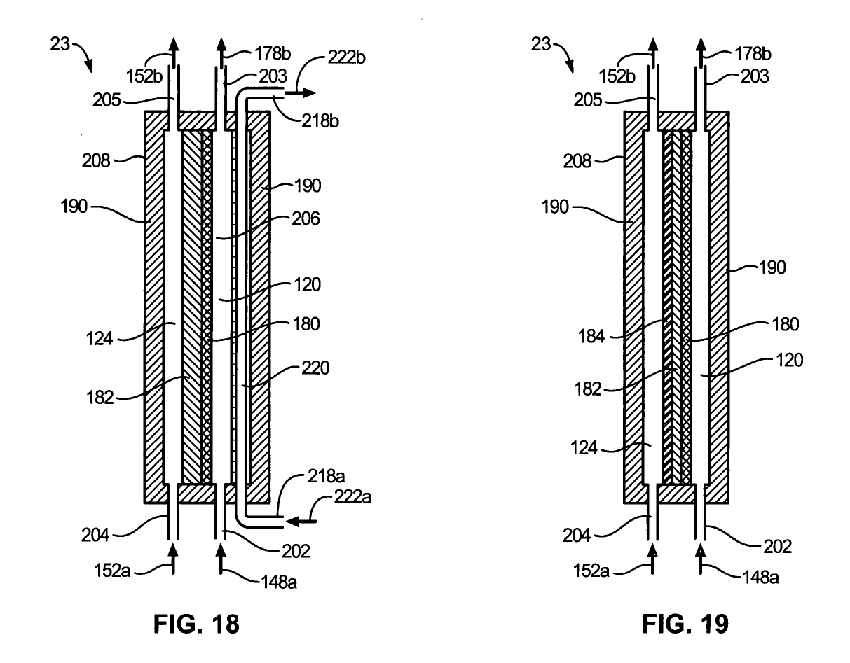

Referring to FIG. 18, a reactor 23 may actually be positioned comparatively remotely from the collection systems and processes. Accordingly, an inlet 218a and outlet 218b may serve a conduit 220 or passage 220 devoted to heat exchange between the contents of the passage 220 and the flow 148 in the passage 120. One may think of the reactor 23 as a double loop system. For example, the actual working fluid in the flow 222 entering the inlet 218a does not actually need to ever change chemically or materially. As a practical matter, the working fluid in the flow 222a may change phase or may simply change temperature. Energy is transferred between the flow 222 in the passage 220, absorbed into the flow 148 in the passage 120, for energizing the ultimate reaction of hydrogen to be migrated through the barrier 182 and catalytic region 180.

Referring to FIG. 19, a plate or cylindrical cross section of a reactor may provide a completely insulated unit. Alternatively, one layer of the insulation 190 may be replaced by either a thermal collecting wall 210, a window 214 (see e.g. FIGS. 15-17), or the like. By whatever mode, the double reaction of the flows 148, 152 may occur at the urging of the catalysts 180, 184, respectively or catalytic regions 180, 184 to produce hydrogen within the passage 120. Hydrogen migrates promptly through to the passage 124, to react at the catalytic region 184 into another hydrogen composition. Ammonia is a typical compound contemplated as an energetic output in implementations of the invention that convert hydrogen into other more easily handled compounds.

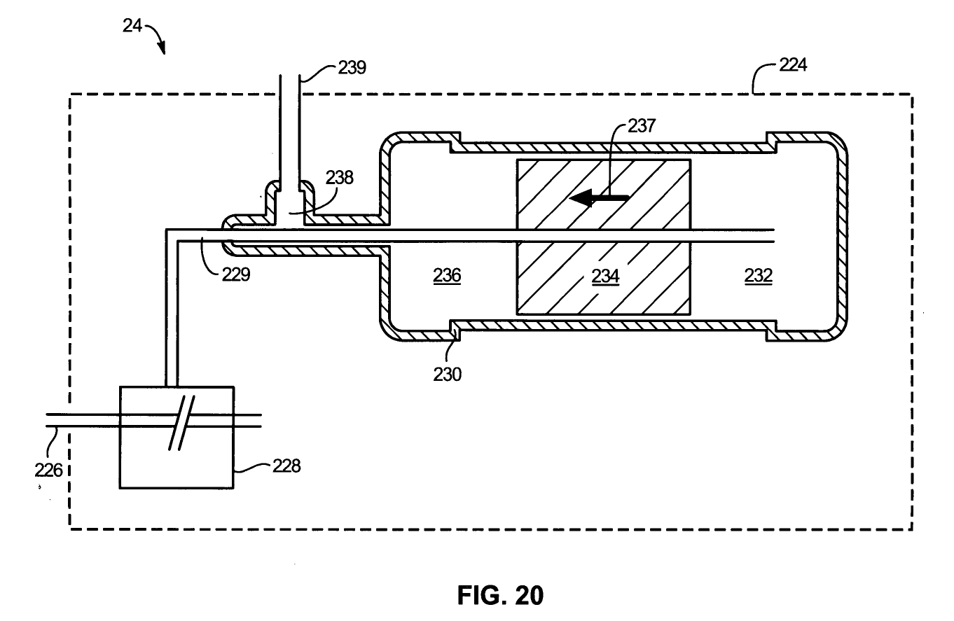

Referring to FIG. 20, a test apparatus for evaluating certain aspects of an apparatus and method in accordance with the invention exists within a boundary 224 of a control volume. Energy passes across the boundary 224 as a thermal load to be converted chemically. In this particular example, an inlet 226 receives water. Water may be received as a liquid at this stage, passing through a heat exchanger 228 receiving heat across the boundary 224, to be introduced into the flow of water in the conduit 229. Meanwhile, the conduit 229 passes through a vessel 230 divided into a plenum or chamber 232 containing primarily steam.

From the chamber 232, a porous catalytic bed 234 or catalyst structure 234 passes the contents of the chamber 232 into the chamber 236. In the process, the elevated temperature, and associated absorption of energy into the flow 237, causes the dissociation of the water into hydrogen and oxygen gas. The residual water has not dissociated.

These constituents flow from the chamber 236 through a passage 238 or neck, which, in this embodiment, provides counterflow over the conduit 229 for heat exchange. Ultimately, the outlet 239 discharges the species of hydrogen, oxygen, and residual water for separation. Thus, the dissociation reactor 24 used for experimental purposes in this embodiment need not rely on a separate sweep gas to carry away the hydrogen, and does not include a semi-permeable boundary to remove hydrogen and promote the shifting of equilibrium in the dissociation reaction toward the dissociated species, hydrogen and oxygen.

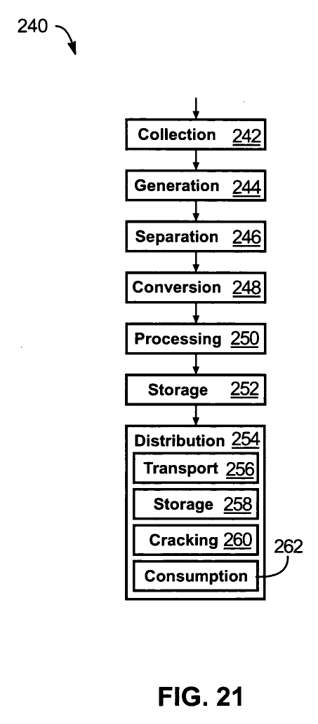

Referring to FIG. 21, a process 240 in accordance with the invention may involve collection 242 of energy, followed by incorporation of that collected energy into the chemical structure of hydrogen from a generation process 244 thereof. Thereafter, a separation 246 of the hydrogen from other species may provide a comparatively clean hydrogen constituent at a suitably pure condition. Conversion 248 is an optional process step in which the hydrogen may be converted into another chemical composition. For example, ammonia or some other compound may actually provide higher densities, more inexpensive, safe, and otherwise reasonable handling and processing, and comparatively modest temperatures and pressures, closer to those of ambient conditions.

Similarly, the conversion process 248 may involve the use of nanofiber matrices to adsorb hydrogen gas, thus providing increased densities. Processing 250 may typically include a suitable number of heat exchanges, pressurizations, and the like as may be required to take the converted, species containing hydrogen (e.g. anhydrous ammonia, etc.) and render them suitable for a storage process 252. Thereafter, distribution 254 may occur by either conventional or novel means.

For example, transport 256, storage 258, and the like may occur multiple times in any particular order. That is, storage 252 proximate a site of a generation process 244 may be appropriate. Nevertheless, population centers and energy generation centers are not necessarily geographically close. Thus, storage 258 and transport 256 may occur repeatedly.

Ultimately, if a conversion process 248 is used, then a cracking process 260 may be required somewhere in the distribution process 254. Cracking 260 may actually occur onboard a vehicle with current technology. Alternatively, cracking may occur in a plant or in a distribution station that then dispenses hydrogen, fuel cells, or some other embodiment of the hydrogen energy. Likewise, consumption 262 may occur by a user, who may be an individual, a driver, or an industrial plant, etc. A certain degree of consumption 262 of materials, energy, or both may occur during the distribution process 254 as a thermodynamic consequence of transport, handling, and conversion processes.

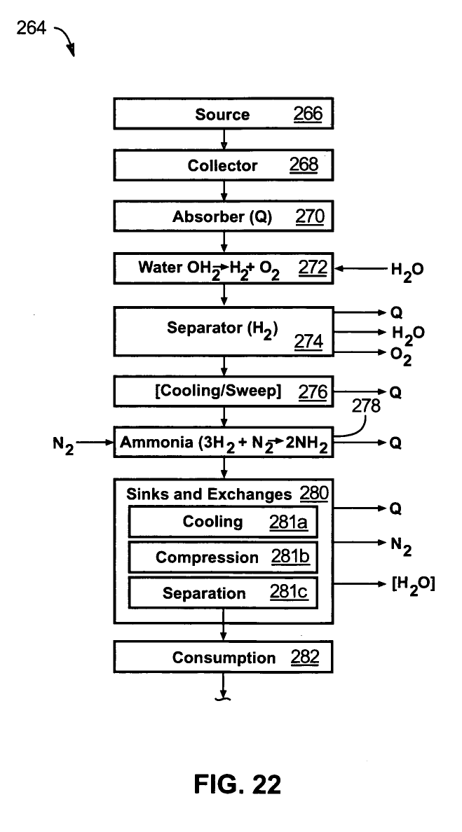

Referring to FIG. 22, an energy path 264 or a process 264 of energy conversion may include origination 266 at a source 266 of energy. Thereafter, a collector 268 may receive the energy. Subsequently, the energy may pass to an absorber 270 as heat. Ultimately, the water 272 should receive sufficient energy to dissociate itself, or at least a portion thereof, into the gaseous species hydrogen and oxygen. A separator 274 may then receive the energy existing in the broken bonds of the water, with the thermodynamic energy of higher availability in hydrogen gas. At the same time, the separator 274 may also reject heat (Q) as well as the excess water and the unwanted oxygen.

An alternate step 276 may involve cooling, sweeping, or both, in combination with one another or with other steps. Energy in the form of heat being rejected may pass out of a cooling or sweeping step 276, or the like. Likewise, the energy may be embodied in ammonia 278, which may reject a certain amount of heat during formation. Ammonia tends to be more stable than hydrogen, less reactive, with a larger threshold energy required to effect a reaction. Meanwhile, nitrogen is introduced and absorbs some of the energy required to form ammonia 278. However, a certain amount of heat may be rejected as the exothermic process of ammonia formation occurs.

Overall, a certain number of heat sinks and exchanges 280 may occur as a result of cooling 281a, compression 281b, separation 281c, and the like. These processes may reject, for example, heat directly through heat exchangers to the environment, may reject nitrogen in the process of separation or compression, and may reject water.

A certain amount of oxygen or hydrogen may be reacted. This may be incident to various processes including the losses due to any thermodynamic process or separation process, as well as certain cleanup and scavenging processes that may be required to react the more reactive constituents rather than allow them to go into the environment unreacted.

Ultimately, a storage system 282 will contain the remaining energy captured in the chemical bounds of the material in which the hydrogen is stored. In one embodiment, the storage 282 is represented by or represents a volume of anhydrous ammonia ready for distribution, cracking, and burning as hydrogen.

Various catalysts have been used including a platinum and rhodium combination as well as platinum-palladium. In one experiment operated at 650° C., a milliliter per minute of fifteen percent oxygen and eight-five percent hydrogen was produced. At 700° C., 3.5 milliliters per minute of five percent oxygen and ninety-five percent hydrogen resulted. At 800° C., ten milliliters per minute of 0.5 percent oxygen and 99.5 percent hydrogen resulted. Finally, at 850° C., sixteen milliliters per minute of 0.2 percent oxygen and 99.8 percent hydrogen resulted from the experiment. The water flow rate was in excess of 0.5 milliliters per minute, but demonstrated the processes.

With a platinum-palladium catalyst, an experiment at 650° C. produced 1.4 milliliters per minute of nineteen percent oxygen and eighty-one percent hydrogen. A 700° C. experiment produced 2.5 milliliters per minute of twelve percent oxygen and eighty-eight percent hydrogen. An 800° C. experiment produced 6.5 milliliters per minute of two percent oxygen and ninety-eight percent hydrogen. An 850° C. experiment produced 13.3 milliliters per minute of 0.5 percent oxygen and 99.5 percent hydrogen.

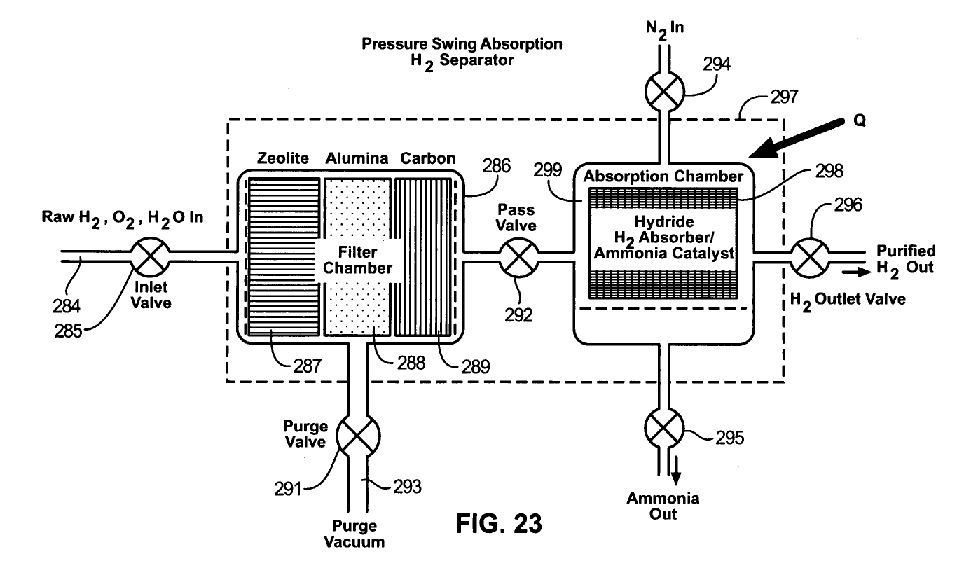

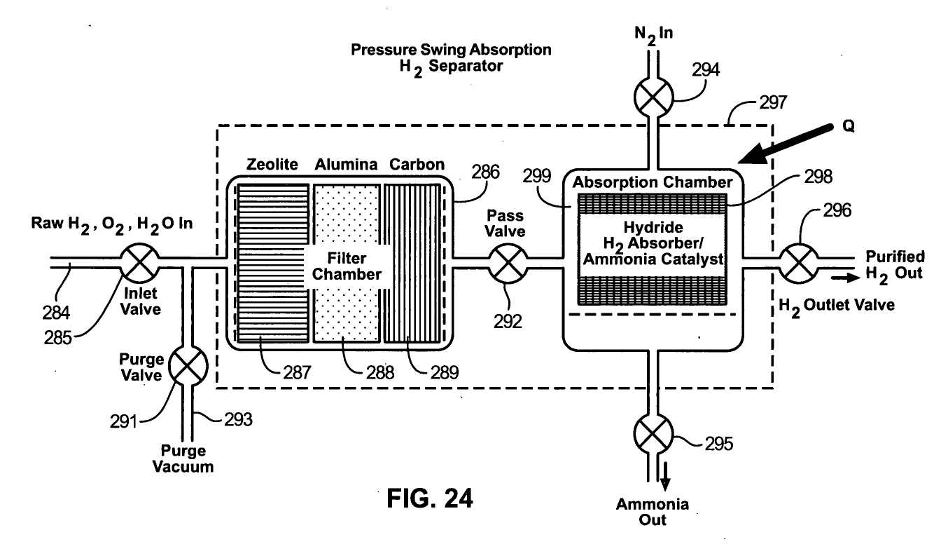

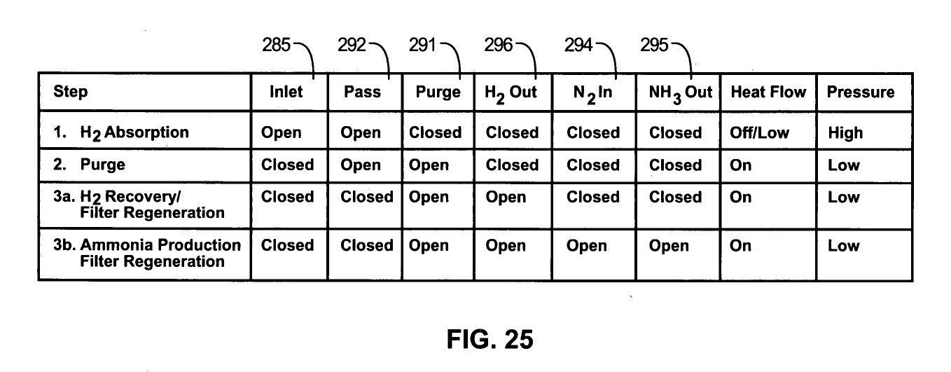

Referring to FIGS. 23-25, an inlet 284 may provide a source of raw hydrogen, oxygen, and residual water from a test apparatus. A valve 285 may provide access of such a flow into a filter chamber 286. The filter chamber may filter out or scavenge elements desired to be removed. For example, minerals and the like may be suitably removed by the filter chamber 286. Meanwhile, the reaction chamber 290 may provide double duty, as an absorption chamber on the one hand in order to purify hydrogen gas, or as a reactor for generating ammonia.

The filter chamber may include, for example, zeolite 287, an alumina portion 288, as well as a carbon portion 289. A valve 292 may direct the output from the filter chamber 286 to the reactor 290. In an alternative embodiment, drawing a vacuum on the valve 291, and opening the valve 291 may allow regeneration of the filter materials 287,288,289 in the filter chamber 286. Meanwhile, if the valve 292 is closed, the valve 291 is open, then the outlet 293 may allow evaporation and evacuation of the scavenged constituents trapped in the zeolite 287, alumina 288, carbon 289, or a combination thereof.

Meanwhile, an additional absorption may occur in the reactor 298 by closing the valves 294, 295, and opening the valve 296. In this way, a hydride absorber may collect a purified hydrogen that can be later discharged through the valve 296. In an alternative configuration of the reactor 290, a catalyst 298 suitable for forming ammonia may be provided while a control volume 297 is heated or otherwise provides heat to the reaction chamber 290 or reactor 290. With nitrogen introduced through the valve 294, and heat provided through the control volume 297 into the reactor 290, along with hydrogen through the valve 292, ammonia may be reacted and discharged through the valve 295. Thus, in an experimental context, the various configurations of the apparatus of FIGS. 23-25 may provide multiple scavenging and reacting operations, as well as a demonstration of processing for either purified hydrogen gas or reacted ammonia.

Referring to FIGS. 23-25, the system 300 may operate in several modes. For example, the system 300 may operate for hydrogen absorption within the chamber 298. In such an embodiment, the valve 285 is open, as well as the valve 292. The valves 291,294,295,296 are all closed. If heat is providing energy across the control volume 297 into the chamber 298, and the pressures within the chambers 286,290 are comparatively high relative to other circumstances, then hydrogen will be absorbed in the material 298 in the chamber 290.

By high pressure is meant pressure on the order of one or more atmospheres over ambient. Typically, several atmospheres pressure may be suitable. Accordingly, pressures will be driven up in a low (near ambient) pressure reactor in such an embodiment. By comparatively low pressure is usually meant less than an atmosphere, and often a fraction of an atmosphere down to very small fractions below one-tenth of an atmosphere, in some instances.

In another configuration, the apparatus 300 of FIGS. 23-25 may implement hydrogen recovery or filter regeneration. In such an embodiment, or configuration of the illustrated embodiment, the valves 291,296 are open to support vacuum and exitive hydrogen. By contrast, the valve 285,292,294,295 are all closed. Meanwhile, to support the process, energy is passed from the control volume 297 or through the control volume 297 into the chamber 290 to provide energy into the material 298. Such an embodiment or configuration may operate at a comparatively low pressure.

In yet another configuration of the apparatus 300, ammonia production or filter regeneration may occur with the valves 294,295 set in an open position. Meanwhile, the valves 285,291,292,296 all remained closed. With energy passing through the control volume 297 into the chamber 290, the system will operate at a comparatively lower pressure. Thus, in this configuration, as contrasted to the hydrogen absorption configuration, energy is provided into the material 298, and the pressure is comparatively low.

By contrast, for hydrogen absorption, no energy need be provided across the control volume 297 in the form of heat. Meanwhile, pressure in the system in such a configuration would be considered to be comparatively higher in order to advance the equilibrium condition to a hydrogen storage condition within the material 298.

In a purge configuration, the valves 285, 294, 295, 296 may all be placed in a closed position. Meanwhile, the valves 291, 292 may be positioned in an open configuration. Accordingly, with a heat flow through the boundary of the control volume 297 into the chamber 290, and a comparatively lower pressure, a purge operation will occur to clean out the system.

Materials available provide some differences in properties, performance, and consequent preferability as to particular roles or applications. Some materials provide suitable behaviors at broader temperature ranges, while others may be more temperamental. On the water dissociation side of a barrier 122 or within any dissociation chamber 120, the water vapor may be exposed to a catalyst suitable for improving the efficiency or rate at which water molecules dissociate to hydrogen and oxygen.

Catalysts or catalytic compositions contemplated for this role may be selected from, for example, platinum, platinum/rhodium combination, platinum/palladium combination, iron (at comparatively higher temperatures on the order of 700° C.), ferrous and ferric iron (at comparatively higher temperatures on the order of 700° C.), nano-platinum, cuprous chloride, manganous chloride, nickel, cerium, ytterbium, praseodymium doped with iron, or the like.

In any compounding reactor, hydrogen may be compounded to form a material to render the hydrogen more stable; less reactive; liquid at reduced pressure closer to ambient, higher temperature closer to ambient, or both; or otherwise more tractable and economical to handle, store, transport, and so forth. A catalyst may suitably improve yield, efficiency, effective operating temperatures, threshold energy of reaction or the like to support such a chemical reaction.

One suitable compound for hydrogen storage, transport, and distribution is anhydrous ammonia. An ammonia-reaction catalyst may typically be selected from lanthanum pentanickel, mischmetal pentanickel, or the like. Other catalysts more conventionally relied upon may be used. However, in one presently contemplated embodiment, the temperature range for ammonia production may be on the order of 300° C. to about 600° C.

Lanthanum pentanickel and mischmetal pentanickel seem to perform best in the lower range, on the order of 300° C. to 450° C. They tend to poison or become otherwise ineffective between about 500° C. and 600° C. However, temperatures above 500° C. may be used in some embodiments. Nevertheless, suitable operation has been shown for reactors with suitable durability making ammonia below 500° C. using these pentanickel compositions.

Separation barriers 122 may be made of one or more materials selected from ceramic, metal, organic, materials, and the like. In some embodiments, such semi-permeable barriers act almost like sieves or filters. In other embodiments, they may act more like solid electrolytes passing ions or protons. Proton filter materials may be made from one or more materials selected from inorganic hydrogen containing salts with large cations and large anions (bi-salts). These maybe pressed, infiltrated in conductive mesh, or both. In some embodiments they may be mixed in conductive high temperature plastics.

Polymeric materials serving as separation membranes or barriers 122 may be formed of material selected from fluorocarbon (e.g. Teflon™) sulfonates. Such are the Nafion™ type. Ceramic materials for proton membranes may be of many types, and may be infiltrated inorganic bi-salts. Also, some forms of carbon nanofibers may also serve as proton membranes.

Oxygen filters may typically be selected from ceramic-metallic or cermet type ceramics. When molecular sieves are used, they may be selected from materials including zeolites (natural and synthetic), porous metal sheaths with thin-coat synthetic zeolite or a nano-pore ceramic. Porous metal or ceramic sheaths may be coated with carbon nanofibers in a layer on a plate or tube shape.

Absorbents and absorbents for collecting oxygen may be selected from sulfite, silica gel, alumina, zeolite, copper II salt, vanadium II salt (which may require reduction), carbon, iron or ferrous alloys from scrap, or the like. Materials for trapping hydrogen in certain embodiments of apparatus in accord with the invention may include an iron-titanium composition, lanthanum pentanickel, carbon nanofiber, an ammonia composition, or the like.

In one example, a combination of platinum and rhodium was used as a catalyst in a dissociation chamber 230 corresponding to FIG. 20. Production of gases occurred at 650° C. at a rate of one milliliter per minute in the simple, non-separating configuration of FIG. 23 wherein the output gases were not separated. The output gases yielded 85% hydrogen with 15% oxygen. At 700° C., the production was up to 3.5 milliliters per minute at 95% hydrogen and 5% oxygen. At 800° C., the production was 10 milliliters per minute at 99.5% hydrogen and 0.5% oxygen. At 850° C., production was 16 milliliters per minute of gas at 99.8% hydrogen and 0.2% oxygen.

In another example, a combination of platinum and palladium was used as a catalyst in a dissociation chamber. Production of gases 650° C. occurred at a rate of 1.4 milliliters per minute in a non-separating configuration. The output gases yielded 81% hydrogen with 19% oxygen. At 700° C., the production was up to 2.5 milliliters per minute at 88% hydrogen and 12% oxygen. At 800° C., the production was 6.5 milliliters per minute at 98% hydrogen and 2% oxygen. At 850° C., production was 13.3 milliliters per minute of gas at 99.5% hydrogen and 0.5% oxygen.

In one example, it has been found that one may obtain hydrogen and oxygen at temperatures lower than reported in conventional literature. In one embodiment, an apparatus and method in accordance with the invention produce hydrogen from water dissociation at temperatures as low as 750° C.

In a system containing iron, such as in the form of carbon steel, a temperature of 800° C. creates hydrogen while most of the oxygen in the system is converted to iron oxide, yielding hydrogen with a reduced level of contaminating oxygen. At 850° C. the data indicate hydrogen recovered practically devoid of oxygen. Thus hydrogen sufficiently pure for most practical industrial processes is produced. It is believed by the inventors that the absorption of oxygen is also contributing to the reduction of temperature by causing an equilibrium shift. The removal of oxygen is a further advantage in that it removes the possibility of an explosive mixture of hydrogen and oxygen from the system.

Oxygen absorption by more active metals, such as zinc, may be useful for solar thermal decomposition of water. However, such a reaction or process is not a direct decomposition as shown in the example in accord with the invention. Reacting an active metal with hot water to form hydrogen and the metal oxide, then reducing the oxide in a solar furnace to recycle the metal requires an extremely hot (on the order of 2000° C.) environment to reduce the metal for reuse.

In the instant circumstance, an active metal (more active than iron) apparently would further reduce the effective temperature of decomposition and obtain oxygen-free hydrogen in the process. The metal oxide, such as zinc oxide, can be reduced using carbon to produce carbon dioxide (ultimately) and the metal, which, as in the referenced process, can be recycled. Carbon reduction can be accomplished at temperatures much lower than the thermal decomposition utilized by other high temperature systems.

Some advantages of the instant process are that it allows the generation of hydrogen driven by solar energy at a lower temperature and simultaneously removes the oxygen from the system. The active metal maybe recycled. Carbon dioxide may be generated at a source location and may be captured and used rather than being emitted. Because the operating temperatures are reduced, the construction materials are less expensive.

This example represents a hybrid, using solar and stored chemical energy to bring about the production of a clean fuel that can be utilized for combustion, reaction in fuel cells, chemical reductions, or hydrogenations of various sorts.

Those of ordinary skill in the art will, of course, appreciate that various modifications to the detailed Figures may easily be made without departing from the essential characteristics of the invention, as described in connection with the Figures above. Thus, the description here is intended only by way of example, and simply illustrates certain presently contemplated embodiments consistent with the invention as claimed herein.

From the above discussion, it will be appreciated that an apparatus and method in accordance with the present invention provides one or more of solar energy collection, water dissociation, hydrogen separation, optional hydrogen adsorption or reaction, followed by storage, transport, and distribution. The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for producing hydrogen, the apparatus comprising:
a collector of radiation to concentrate solar radiation on a converter;
the converter having an absorptivity with respect to solar radiation to substantially convert the solar radiation to thermal energy, introduce the thermal energy to an input chemical, and drive a chemical process using the input chemical as a feedstock to produce an output chemical and a byproduct chemical;
a separator to separate the output chemical from the byproduct chemical;
a reactor to react the output chemical to form a storage chemical, reactive to produce energy but sufficiently stable for safe handling outside designation as an energetic material; and
a processor to modify at least one of the density, temperature, and pressure of the storage chemical for transportation and handling.

2. The apparatus of claim 1, wherein an energetic material has a characteristic selected from explosive, readily combustible at substantially ambient conditions, readily ignitable by at least one of a spark and a sustained flame at ambient conditions, detonable at conditions corresponding to common transportation and handling, and detonable upon exposure to a shock under ambient conditions.

3. The apparatus of claim 1, wherein the collector comprises reflector formed to be substantially flat to maintain a diffusion of the energy impinging on the converter.

4. The apparatus of claim 1, wherein the converter comprises a window formed of a material selected to pass solar radiation and substantially resist passage of the thermal energy re-radiated from the collector.

5. The apparatus of claim 1, further comprising a counterflow heat exchanger having first and second passages operably connected to receive, respectively, the feedstock and at least one of the output chemical and the byproduct chemical, exchanging heat therebetween to heat the feedstock.

6. The apparatus of claim 1, further comprising a heat exchanger having a wall, dividing first and second passages, across which energy is transferred from the byproduct chemical to the feedstock to recycle energy from the byproduct chemical to pre-heat the feedstock.

7. The apparatus of claim 1, wherein the converter and reactor are integrated with the separator to share a single wall and material common to all.

8. The apparatus of claim 7, wherein the separator comprises a porous wall defined by first and second surfaces opposite one another, the first surface bounding a first passage carrying the feedstock, absorbing solar radiation from the collector, converting the solar radiation to thermal energy, and passing the thermal energy into the feedstock.

9. The apparatus of claim 8, wherein:
the porous wall has a porosity selected to pass the output chemical and substantially block passage of the byproduct chemical therethrough,
the second surface bounds a second passage carrying the output chemical away therefrom;
the converter comprises the first passage and the first surface of the wall, which first passage operates to carry away the byproduct chemical; and
the reactor comprises at least one of the second passage and the second surface of the wall.

10. The apparatus of claim 1, wherein the converter further comprises a surface having a catalyst disposed thereon to dissociate the first chemical into the output chemical and the byproduct chemical.

11. The apparatus of claim 1, further comprising:
a conduit conducting the output chemical from the separator to the reactor;
a heat exchanger operably connected to the conduit to remove heat from the output chemical and reduce the temperature thereof; and
the reactor, further including a catalytic surface to convert the output chemical to the storage chemical.

12. The apparatus of claim 1, wherein the reactor further comprises:
a first conduit conducting the output chemical and a sweep chemical therethrough;
a first catalyst located within the first conduit and selected to react the output chemical and the sweep chemical to form the storage chemical.

13. The apparatus of claim 12, wherein the output chemical is hydrogen, the sweep chemical is nitrogen, and the storage chemical is ammonia.

14. The apparatus of claim 12, wherein the first catalyst comprises a metal.

15. The apparatus of claim 12, wherein the converter comprises a chamber having a wall defined by a porous material having a porosity sized to pass the output chemical and block passage of the feedstock.

16. The apparatus of claim 15, wherein the wall has first and second surfaces, the second surface operating to convert the solar radiation to thermal energy and being coated with a second catalyst to dissociate the feedstock into hydrogen, as the output chemical, and the byproduct chemical.

17. The apparatus of claim 16 wherein the first surface is coated with the first catalyst operating to react the output chemical to produce the storage chemical

18. The apparatus of claim 17, wherein the wall is formed of a ceramic having the first and second surfaces opposite one another.

19. The apparatus of claim 1, further comprising:
a tracking system to determine and control the orientation of the collector with respect to the sun;
a storage system to hold the storage chemical for transport; and
a system of heat exchangers to recover thermal energy from at least one of the byproduct chemical and the output chemical into the feedstock to improve the energy efficiency of the apparatus.

20. An apparatus for generating an exothermically reactive composition comprising hydrogen, the apparatus comprising:
a solar collector for collecting incident radiation in the electromagnetic spectrum to be redirected as redirected radiation;
a generator comprising:
an energy conversion system to convert redirected radiation to thermal energy;
a reactor receiving the thermal energy to dissociate water at temperatures less than 1800 degrees centigrade, producing hydrogen and byproducts therefrom; and
a separator to separate the hydrogen from the byproducts; and
a processor to reformulate the hydrogen into a compound of hydrogen stable at substantially standard temperature and pressure and reactive to produce energy.

21. An apparatus for generating ammonia as a reactive hydrogen compound for subsequent exothermic reaction as a fuel, the apparatus comprising:
a solar collector for collecting radiation in the electromagnetic spectrum incident thereon from the sun, concentrating the radiation, and redirecting the radiation to a converter;
a generator comprising:
the converter to convert radiation redirected thereto into thermal energy;
a reactor comprising a first catalyst, the reactor receiving the thermal energy, introducing the thermal energy to water, directly dissociating the water thermally at a temperature substantially less than 1800 degrees centigrade, and producing hydrogen and byproducts therefrom; and
a separator to filter non-electronically the hydrogen from the byproducts; and a processor to reformulate the hydrogen into ammonia liquid to be stable proximate substantially standard temperature and pressure.

22. The apparatus of claim 21, wherein the collector, generator, and processor are integrated and supported on a movable support to move with one another and the solar collector.

23. The apparatus of claim 21, wherein the separator further comprises a barrier, semi-permeable and having a porosity sized to substantially pass hydrogen therethrough and to substantially block oxygen and water from passing therethrough.

24. The apparatus of claim 23, wherein the barrier has walls defining passages constituting porosity and the first catalyst is coated on the walls.

25. The apparatus of claim 24, wherein the separator further comprises a reaction chamber and a sweep chamber on opposite sides of the barrier, the sweep chamber carrying nitrogen to sweep hydrogen away from the barrier to urge an equilibrium condition producing more hydrogen in the reaction chamber.

26. The apparatus of claim 25, wherein the barrier proximate the sweep chamber is coated with a second catalyst selected to promote reaction of the nitrogen with the hydrogen to form ammonia.

27. The apparatus of claim 21, wherein the first catalyst is formed as a surface having a porosity sized to pass hydrogen and block oxygen, forming thereby the reactor and separator.

28. The apparatus of claim 21, wherein the separator comprises a scavenger comprising a material reactive with oxygen to remove oxygen from the hydrogen.

29. The apparatus of claim 21, wherein the separator comprises a binding material to selectively absorb hydrogen to the exclusion of the byproducts.

30. The apparatus of claim 29, further comprising a purge mechanism to recover the hydrogen from the binding material.

31. The apparatus of claim 21 wherein the separator further comprises carbon nano-fibers oriented and positioned opposite the water with respect to the first catalyst to filter oxygen from the hydrogen and to draw the hydrogen away from the first catalyst.

32. An apparatus for generating a chemical having an exothermic reactivity, the apparatus comprising:
a collector for collecting energy from a source thereof;
a generator comprising:
a conversion system to convert at least one first chemical species and energy into a second chemical species and first byproducts;
a separation system to separate the second chemical species from the first byproducts; and
a first processor to stabilize the second chemical species for use as a feedstock to produce energy and a second byproduct; and
a second processor to provide energy to the first and second byproducts and regenerate the at least one first chemical species therefrom.

33. An apparatus for storing solar energy as chemical energy, the apparatus comprising:
a source of water;
a collector of solar radiation;
a collector for converting solar radiation to thermal energy and introducing that thermal energy into the water;
a frame containing an array of mirrors fixed in an orientation to reflect incoming radiation to the collector, and to maintain all the mirrors in the array in substantially rigid body relation to one another and to the frame and with respect to the collector;
a drive system comprising motors for orienting the frame in order to optimize the received incoming radiation from the sun;
a pivot system for aiming the array and associated frame with respect to the direction of incoming solar radiation;
a base for mounting the pivot with respect to the earth;
a reactor for providing the heated water and a catalyst in order to dissociate hydrogen and oxygen from one another;
a dryer for removing water from the hydrogen;
a separator for removing dissociated oxygen from the water;
a drive mechanism for moving the hydrogen; and
a storage system for storing the hydrogen.

34. The apparatus of claim 32 further comprising a processor to react the hydrogen into a composition more readily adaptable to storage of the hydrogen in the storage system.

35. The apparatus of claim 32, wherein the state of the hydrogen is selected from gaseous hydrogen, liquid hydrogen, nanofiber binding of gaseous hydrogen, and a liquid composition of hydrogen.
